(19) United States
(12) Patent Application Publication
(10) Pub. No.: US 2011/0183012 A1
(43) Pub. Date: Jul. 28, 2011

(54) Pesticidal Mixtures

(75) Inventors: Markus Gewehr, Kastellaun (DE); Michael Puhl, Lampertheim (DE); Joachim Dickhaut, Heidelberg (DE); Henricus Maria Martinus Bastiaans, Usingen (DE); Douglas D. Anspaugh, Apex, NC (US); David G. Kuhn, Apex, NC (US); Hassan Oloumi-Sadeghi, Raleigh, NC (US); Nigel Armes, Raleigh, NC (US)

(73) Assignee: BASF Aktiengesellschaft, Ludwigshafen (DE)

(21) Appl. No.: 12/161,506

(22) PCT Filed: Jan. 12, 2007
(86) PCT No.: PCT/EP07/50280

§ 371 Date: Oct. 16, 2008

Related U.S. Application Data
(60) Provisional application No. 60/760,532, filed on Jan. 20, 2006.

(51) Int. Cl. A01N 59/02; A01N 43/40; A01N 43/56; A01N 57/14; A01N 57/12; A01N 43/54; A01N 57/16; A01N 43/16; A01N 43/58; A01N 43/24; A01N 43/88; A01P 5/00; A01P 7/00; A01P 7/02; A01P 7/04

(52) U.S. Cl. 424/703; 514/341; 514/407; 514/132; 514/342; 514/120; 514/275; 514/80; 514/128; 514/345; 514/53; 514/247; 514/357; 514/28; 514/229.2; 514/355

(57) ABSTRACT

Pesticidal mixtures comprising, as active components,
1) an anthranilamid compound of the formula I

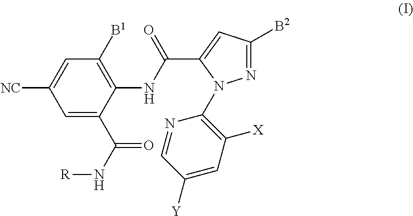

wherein
Q is H, Cl, Cr, I, CN or methyl;
B¹ is halogen, alkyl, haloalkyl, or haloalkoxy;
B² is halogen, haloalkyl, alkoxy, haloalkoxy, alkenyloxy, alkynyloxy, alkylthio, haloalkylthio, alkylsulfinyl, haloalkylsulfinyl, alkylsulfonyl, haloalkylsulfonyl, alkyl-S(═O)ₓ—O— or haloalkyl S(O)ₓ—O—, wherein x is 1 or 2 and the alkoxy radical may be substituted, or C(Rⁱ)═N—OR^{j}, C(Rⁱ)═N(R^{j}R^{k}), wherein Rⁱ, R^{j} and R^{k} are alkyl;
R is hydrogen, alkyl, alkenyl, alkynyl, cycloalkyl, alkylene-cycloalkyl, wherein these groups are optionally substituted;
R¹ is F, Cl, Br, methyl or trifluoromethyl; or the enantiomers or salts or N-oxides thereof,
n is 1, 2 or 3; and
2) one or more compounds II selected from group A consisting of organo(thio)-phosphates, carbamates, pyrethroids, growth regulators, nicotinic receptor agonists/antagonists compounds, GABA antagonist compounds, macrocyclic lactone insecticides, METI I acaricides, METI II and III compounds, uncoupler compounds, oxidative phosphorylation inhibitor compounds, mixed function oxidase inhibitor compounds, sodium channel blocker compounds and others, all as defined in the description, in synergistically effective amounts,
use of these mixture for combating insects, arachnids or nematodes in and on plants and for the protection of seeds, and for treating, controlling, preventing or protecting a warm-blooded animal or a fish against infestation or infection by parasites.

The present invention relates to pesticidal mixtures comprising, as active components

Pesticidal mixtures comprising, as active components,

1) an anthranilamid compound of the formula I

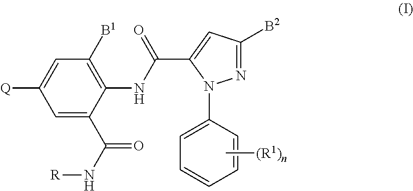

wherein

Q is hydrogen, chloro, bromo, iodo, cyano or methyl;

B¹ is halogen, C₁-C₄-alkyl, C₁-C₄-haloalkyl, or C₁-C₄haloalkoxy;

B² is halogen, C₁-C₄-haloalkyl, C₁-C₄-alkoxy, C₁-C₄-haloalkoxy, C₁-C₄-alkenyloxy, C₁-C₄alkynyloxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₄-alkyl-S(═O)ₓ—O— or C₁-C₄-haloalkyl S(O)ₓ—O—, wherein x is 1 or 2 and the C₁-C₄-alkoxy radical may be substituted with 1-6 groups selected from halogen, cyano, C₁-C₄-alkoxy, C₁-C₄-alkoxycarbonyl or C(Rⁱ)═N—OR^{j}, C(Rⁱ)═N(R^{j}R^{k}), wherein Rⁱ, R^{j} and R^{k} are each independently C₁-C₄-alkyl;

R is hydrogen, C₁-C₆-alkyl, C₂-C₆-alkenyl, C₂-C₆-alkynyl, C₃-C₆-cycloalkyl, C₁-C₄-alkylene-C₃-C₆-cycloalkyl, wherein these groups are unsubstituted or substituted with from 1 to 3 groups selected from halogen, cyano, nitro, C₁-C₆-alkyloxycarbonyl, amino, C₁-C₆-alkylamino, di(C₁-C₆-alkyl)amino, C₁-C₆-alkoxy, C₁-C₆-thioalkyl, C₁-C₆-alkylsulfinyl, C₁-C₆-alkylsulfonyl;

R¹ is fluoro, chloro, bromo, methyl, or trifluoromethyl;

n is 1, 2 or 3;

or the enantiomers or salts or N-oxides thereof, and

2) one or more compounds II selected from group A consisting of

A.1. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;

A.2. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;

A.3. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;

A.4. Growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;

A.5. Nicotinic receptor agonists/antagonists compounds: clothianidin, dinotefuran, imidacloprid, thiamethoxam, nitenpyram, acetamiprid, thiacloprid;

A.6. GABA antagonist compounds: acetoprole, endosulfan, ethiprole, fipronil, vaniliprole, pyrafluprole, pyriprole, the phenylpyrazole compound of formula Γ¹

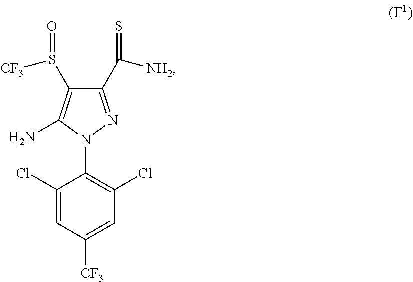

A.7. Macrocyclic lactone insecticides: abamectin, emamectin, milbemectin, lepimectin, spinosad;

A.8. METI I acaricides: fenazaquin, pyridaben, tebufenpyrad, tolfenpyrad, flufenerim;

A.9. METI II and III compounds: acequinocyl, fluacyprim, hydramethylnon;

A.10. Uncoupler compounds: chiorfenapyr;

A.11. Oxidative phosphorylation inhibitor compounds: cyhexatin, diafenthiuron, fenbutatin oxide, propargite;

A.12. Moulting disruptor compounds: cryomazine;

A.13. Mixed Function Oxidase inhibitor compounds: piperonyl butoxide;

A.14. Sodium channel blocker compounds: indoxacarb, metaflumizone,

A.15. Various: benclothiaz, bifenazate, cartap, flonicamid, pyridalyl, pymetrozine, sulfur, thiocyclam, flubendiamide, cyenopyrafen, flupyrazofos, cyflumetofen, amidoflumet, N—R′-2,2-dihalo-1-R″cyclo-propanecarboxamide-2-(2,6-dichloro-α,α,α-tri-fluoro-p-tolyl)hydrazone or N—R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl, wherein Rⁱ is —CH₂OCH₂CH₃ or H and Rⁱⁱ is CF₂CF₂CF₃ or CH₂CH(CH₃)₃, anthranilamide compounds of formula Γ²

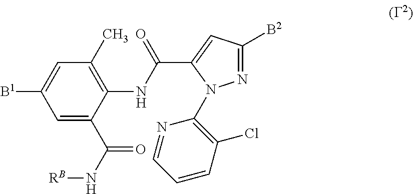

wherein B¹ is hydrogen, CN or a chlorine atom, B² is a bromine or chlorine atom, CF₃, OCH₂CF₃ or OCF₂H, and R^{B} is hydrogen, CH₃ or CH(CH₃)₂, and malononitrile compounds as described in JP 2002 284608, WO 02/89579, WO 02/90320, WO 02/90321, WO 04/06677, WO 04/20399, or JP 2004 99597,

in synergistically effective amounts.

The present invention also provides methods for the control of insects, acarids or nematodes comprising contacting the insect, acarid or nematode or their food supply, habitat, breeding grounds or their locus with a pesticidally effective amount of mixtures of the compound I with one or more compounds II.

Moreover, the present invention also relates to a method of protecting plants from attack or infestation by insects, acarids or nematodes comprising contacting the plant, or the soil or water in which the plant is growing, with a pesticidally effective amount of a mixture of the compound I with one or more compounds II.

This invention also provides a method for treating, controlling, preventing or protecting an animal against infestation or infection by parasites which comprises orally, topically or parenterally administering or applying to the animals a parasiticidally effective amount of a mixture of the compound I with one or more compounds II.

The invention also provides a process for the preparation of a composition for treating, controlling, preventing or protecting a warm-blooded animal or a fish against infestation or infection by insects, acarids or nematodes which comprises a pesticidally effective amount of a mixture of the compound I with one or more compounds II.

One typical problem arising in the field of pest control lies in the need to reduce the dosage rates of the active ingredient in order to reduce or avoid unfavorable environmental or toxicological effects whilst still allowing effective pest control.

Another problem encountered concerns the need to have available pest control agents which are effective against a broad spectrum of pests.

There also exists the need for pest control agents that combine know-down activity with prolonged control, that is, fast action with long lasting action.

Another difficulty in relation to the use of pesticides is that the repeated and exclusive application of an individual pesticidal compound leads in many cases to a rapid selection of pests which have developed natural or adapted resistance against the active compound in question. Therefore there is a need for pest control agents that help prevent or overcome resistance.

It was therefore an object of the present invention to provide pesticidal mixtures which solve the problems of reducing the dosage rate and/or enhancing the spectrum of activity and/or combining know-down activity with prolonged control and/or to resistance management.

We have found that this object is in part or in whole achieved by the combination of active compounds defined at the outset. Moreover, we have found that simultaneous, that is joint or separate, application of a compound I and one or more compounds II or successive application of a compound I and one or more compounds II allows enhanced control of pests compared to the control rates that are possible with the individual compounds.

Compounds of the formula I, their preparation and their action against insect and acarid pests are known from WO 05/118552.

The commercially available compounds of the group A may be found in The Pesticide Manual, 13^{th} Edition, British Crop Protection Council (2003) among other publications. Thiamides of formula Γ² and their preparation have been described in WO 98/28279. Lepimection is known from Agro Project, PJB Publications Ltd, November 2004. Benclothiaz and its preparation have been described in EP-A1 454621. Methidathion and Paraoxon and their preparation have been described in Farm Chemicals Handbook, Volume 88, Meister Publishing Company, 2001. Acetoprole and its preparation have been described in WO 98/28277. Metaflumizone and its preparation have been described in EP-A1 462 456. Flupyrazofos has been described in Pesticide Science 54, 1988, p. 237-243 and in U.S. Pat. No. 4,822,779. Pyrafluprole and its preparation have been described in JP 2002193709 and in WO 01/00614. Pyriprole and its preparation have been described in WO 98/45274 and in U.S. Pat. No. 6,335,357. Amidoflumet and its preparation have been described in U.S. Pat. No. 6,221,890 and in JP 21010907. Flufenerim and its preparation have been described in WO 03/007717 and in WO 03/007718. Cyflumetofen and its preparation have been described in WO 04/080180.

Mixtures, active against pests, of compounds of formula I with some of the compounds of formula II are described in WO 05/118552. The favourable synergistic effect of these mixtures is not mentioned in these documents but is described herein for the first time.

With regard to their use in the pesticidal mixtures of the present invention, compounds of formula I.1 are especially preferred:

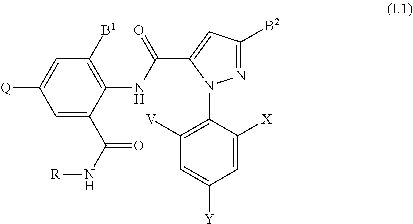

wherein

Q is chloro, bromo, iodo or cyano;

B¹ is chloro, bromo, iodo, or methyl;

B² is chloro, bromo, trifluoromethyl, 2,2,2-trifluoroethoxy, difluoromethyl;

R is hydrogen or C₁-C₄-alkyl which may be substituted with CN or SCH₃;

X is fluoro, chloro or bromo;

Y is hydrogen, fluoro or chloro;

V is hydrogen, fluoro or chloro;

or the enantiomers or salts or N-oxides thereof.

Moreover, with regard to their use in the pesticidal mixtures of the present invention, compounds of formula I.1 are especially preferred wherein

Q is chloro or cyano;

B¹ is chloro, bromo or methyl;

B² is chloro, bromo or trifluoromethyl;

R is hydrogen, methyl, ethyl, isopropyl or tert.-butyl;

X is fluoro, chloro or bromo;

Y is hydrogen, fluoro or chloro;

V is hydrogen, fluoro or chloro;

or the enantiomers or salts or N-oxides thereof.

With respect to their use in the pesticidal mixtures of the present invention, particular preference is given to the compounds IA compiled in the tables below. Moreover, the groups mentioned for a substituent in the tables are on their own, independently of the combination in which they are mentioned, a particularly preferred embodiment of the substituent in question.

Table 1

Compounds of the formula IA wherein Q is chlorine, X and Y are fluorine, V is hydrogen and the combination of B¹, B² and R in each case corresponds to a row of Table A.

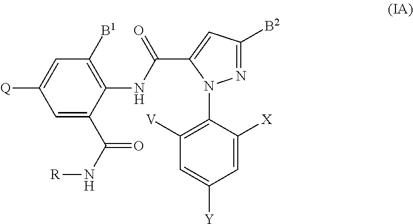

Table 2

Compounds of the formula IA wherein Q is chlorine, X and Y are chlorine, V is hydrogen and the combination of B¹, B² and R in each case corresponds to a row of Table A.

Table 3

Compounds of the formula IA wherein Q is chlorine, X and V are chlorine, Y is hydrogen and the combination of B¹, B² and R in each case corresponds to a row of Table A.

Table 4

Compounds of the formula IA wherein Q is chlorine, X and V are fluorine, Y is hydrogen and the combination of B¹, B² and R in each case corresponds to a row of Table A.

Table 5

Compounds of the formula IA wherein Q is chlorine, X is fluorine, Y are chlorine, V is hydrogen and the combination of B¹, B² and R in each case corresponds to a row of Table A.

Table 6

Compounds of the formula IA wherein Q is chlorine, X is chlorine, Y are fluorine, V is hydrogen and the combination of B¹, B² and R in each case corresponds to a row of Table A.

Table 7

Compounds of the formula IA wherein Q is chlorine, X is fluorine and Y and V are hydrogen and the combination of B¹, B² and R in each case corresponds to a row of Table A.

Table 8

Compounds of the formula IA wherein Q is chlorine, X is chlorine and Y and V are hydrogen and the combination of B¹, B² and R in each case corresponds to a row of Table A.

Table 9

Compounds of the formula IA wherein Q is chlorine, X is bromine and Y and V are hydrogen and the combination of B¹, B² and R in each case corresponds to a row of Table A.

Table 10

Compounds of the formula IA wherein Q is chlorine, X, Y and V are chlorine and the combination of B¹, B² and R in each case corresponds to a row of Table A.

Table 11

Compounds of the formula IA wherein Q is chlorine, X, Y and V are fluorine and the combination of B¹, B² and R in each case corresponds to a row of Table A.

Table 12

Compounds of the formula IA wherein Q is cyano, X and Y are fluorine, V is hydrogen and the combination of B¹, B² and R in each case corresponds to a row of Table A.

Table 13

Compounds of the formula IA wherein Q is cyano, X and Y are chlorine, V is hydrogen and the combination of B¹, B² and R in each case corresponds to a row of Table A.

Table 14

Compounds of the formula IA wherein Q is cyano, X and V are chlorine, Y is hydrogen and the combination of B¹, B² and R in each case corresponds to a row of Table A.

Table 15

Compounds of the formula IA wherein Q is cyano, X and V are fluorine, Y is hydrogen and the combination of B¹, B² and R in each case corresponds to a row of Table A.

Table 16

Compounds of the formula IA wherein Q is cyano, X is fluorine, Y are chlorine, V is hydrogen and the combination of B¹, B² and R in each case corresponds to a row of Table A.

Table 17

Compounds of the formula IA wherein Q is cyano, X is chlorine, Y are fluorine, V is hydrogen and the combination of B¹, B² and R in each case corresponds to a row of Table A.

Table 18

Compounds of the formula IA wherein Q is cyano, X is fluorine and Y and V are hydrogen and the combination of B¹, B² and R in each case corresponds to a row of Table A.

Table 19

Compounds of the formula IA wherein Q is cyano, X is chlorine and Y and V are hydrogen and the combination of B¹, B² and R in each case corresponds to a row of Table A.

Table 20

Compounds of the formula IA wherein Q is cyano, X is bromine and Y and V are hydrogen and the combination of B¹, B² and R in each case corresponds to a row of Table A.

Table 21

Compounds of the formula IA wherein Q is cyano, X, Y and V are chlorine and the combination of B¹, B² and R in each case corresponds to a row of Table A.

Table 22

Compounds of the formula IA wherein Q is cyano, X, Y and V are fluorine and the combination of B¹, B² and R in each case corresponds to a row of Table A.

TABLE A

| No. | B¹ | B² | R |
|---|---|---|---|
| IA-1 | Cl | Br | H |
| IA-2 | Cl | Cl | H |
| IA-3 | Cl | CF₃ | H |
| IA-4 | Cl | OCH₃ | H |
| IA-5 | Cl | OCH₂CH₃ | H |
| IA-6 | Cl | OCH₂CF₃ | H |
| IA-7 | Cl | OCF₃ | H |
| IA-8 | Cl | OCFCF₂ | H |
| IA-9 | Cl | OCH₂CN | H |
| IA-10 | Cl | OCH₂CCH | H |
| IA-11 | Cl | OCH₂CH₂OCH₃ | H |
| IA-12 | Cl | OCH₂CH₂OCH₂CH₃ | H |
| IA-13 | Cl | SCH₃ | H |
| IA-14 | Cl | SCH₂CH₃ | H |
| IA-15 | Cl | SCF₃ | H |
| IA-16 | Cl | S(═O)CH₃ | H |
| IA-17 | Cl | S(═O)CH₂CH₃ | H |
| IA-18 | Cl | S(═O)CF₃ | H |
| IA-19 | Cl | S(═O)₂CH₃ | H |
| IA-20 | Cl | S(═O)₂CH₂CH₃ | H |
| IA-21 | Cl | S(═O)₂CF₃ | H |
| IA-22 | Cl | —O—S(═O)₂CH₃ | H |
| IA-23 | Cl | —O—S(═O)₂CH₂CH₃ | H |
| IA-24 | Cl | —OCH₂C(═O)OCH₃ | H |
| IA-25 | Cl | CH═N—OCH₃ | H |
| IA-26 | Cl | C(CF₃)═N—OCH₃ | H |
| IA-27 | CH₃ | Br | H |
| IA-28 | CH₃ | Cl | H |
| IA-29 | CH₃ | CF₃ | H |
| IA-30 | CH₃ | OCH₃ | H |
| IA-31 | CH₃ | OCH₂CH₃ | H |
| IA-32 | CH₃ | OCH₂CF₃ | H |
| IA-33 | CH₃ | OCF₃ | H |
| IA-34 | CH₃ | OCFCF₂ | H |
| IA-35 | CH₃ | OCH₂CN | H |
| IA-36 | CH₃ | OCH₂CCH | H |
| IA-37 | CH₃ | OCH₂CH₂OCH₃ | H |
| IA-38 | CH₃ | OCH₂CH₂OCH₂CH₃ | H |
| IA-39 | CH₃ | SCH₃ | H |
| IA-40 | CH₃ | SCH₂CH₃ | H |
| IA-41 | CH₃ | SCF₃ | H |
| IA-42 | CH₃ | S(═O)CH₃ | H |
| IA-43 | CH₃ | S(═O)CH₂CH₃ | H |
| IA-44 | CH₃ | S(═O)CF₃ | H |
| IA-45 | CH₃ | S(═O)₂CH₃ | H |
| IA-46 | CH₃ | S(═O)₂CH₂CH₃ | H |
| IA-47 | CH₃ | S(═O)₂CF₃ | H |
| IA-48 | CH₃ | —O—S(═O)₂CH₃ | H |
| IA-49 | CH₃ | —O—S(═O)₂CH₂CH₃ | H |
| IA-50 | CH₃ | —OCH₂C(═O)OCH₃ | H |
| IA-51 | CH₃ | CH═N—OCH₃ | H |
| IA-52 | CH₃ | C(CF₃)═N—OCH₃ | H |
| IA-53 | Cl | Br | CH₃ |
| IA-54 | Cl | Cl | CH₃ |
| IA-55 | Cl | CF₃ | CH₃ |
| IA-56 | Cl | OCH₃ | CH₃ |
| IA-57 | Cl | OCH₂CH₃ | CH₃ |
| IA-58 | Cl | OCH₂CF₃ | CH₃ |
| IA-59 | Cl | OCF₃ | CH₃ |
| IA-60 | Cl | OCFCF₂ | CH₃ |
| IA-61 | Cl | OCH₂CN | CH₃ |
| IA-62 | Cl | OCH₂CCH | CH₃ |
| IA-63 | Cl | OCH₂CH₂OCH₃ | CH₃ |
| IA-64 | Cl | OCH₂CH₂OCH₂CH₃ | CH₃ |
| IA-65 | Cl | SCH₃ | CH₃ |
| IA-66 | Cl | SCH₂CH₃ | CH₃ |
| IA-67 | Cl | SCF₃ | CH₃ |
| IA-68 | Cl | S(═O)CH₃ | CH₃ |
| IA-69 | Cl | S(═O)CH₂CH₃ | CH₃ |
| IA-70 | Cl | S(═O)CF₃ | CH₃ |
| IA-71 | Cl | S(═O)₂CH₃ | CH₃ |
| IA-72 | Cl | S(═O)₂CH₂CH₃ | CH₃ |
| IA-73 | Cl | S(═O)₂CF₃ | CH₃ |
| IA-74 | Cl | —O—S(═O)₂CH₃ | CH₃ |
| IA-75 | Cl | —O—S(═O)₂CH₂CH₃ | CH₃ |
| IA-76 | Cl | —OCH₂C(═O)OCH₃ | CH₃ |
| IA-77 | Cl | CH═N—OCH₃ | CH₃ |
| IA-78 | Cl | C(CF₃)═N—OCH₃ | CH₃ |
| IA-79 | CH₃ | Br | CH₃ |
| IA-80 | CH₃ | Cl | CH₃ |
| IA-81 | CH₃ | CF₃ | CH₃ |
| IA-82 | CH₃ | OCH₃ | CH₃ |
| IA-83 | CH₃ | OCH₂CH₃ | CH₃ |
| IA-84 | CH₃ | OCH₂CF₃ | CH₃ |
| IA-85 | CH₃ | OCF₃ | CH₃ |
| IA-86 | CH₃ | OCFCF₂ | CH₃ |
| IA-87 | CH₃ | OCH₂CN | CH₃ |
| IA-88 | CH₃ | OCH₂CCH | CH₃ |
| IA-89 | CH₃ | OCH₂CH₂OCH₃ | CH₃ |
| IA-90 | CH₃ | OCH₂CH₂OCH₂CH₃ | CH₃ |
| IA-91 | CH₃ | SCH₃ | CH₃ |
| IA-92 | CH₃ | SCH₂CH₃ | CH₃ |
| IA-93 | CH₃ | SCF₃ | CH₃ |
| IA-94 | CH₃ | S(═O)CH₃ | CH₃ |
| IA-95 | CH₃ | S(═O)CH₂CH₃ | CH₃ |
| IA-96 | CH₃ | S(═O)CF₃ | CH₃ |
| IA-97 | CH₃ | S(═O)₂CH₃ | CH₃ |
| IA-98 | CH₃ | S(═O)₂CH₂CH₃ | CH₃ |
| IA-99 | CH₃ | S(═O)₂CF₃ | CH₃ |
| IA-100 | CH₃ | —O—S(═O)₂CH₃ | CH₃ |
| IA-101 | CH₃ | —O—S(═O)₂CH₂CH₃ | CH₃ |
| IA-102 | CH₃ | —OCH₂C(═O)OCH₃ | CH₃ |
| IA-103 | CH₃ | CH═N—OCH₃ | CH₃ |
| IA-104 | CH₃ | C(CF₃)═N—OCH₃ | CH₃ |
| IA-105 | Cl | Br | CH₂CH₃ |
| IA-106 | Cl | Cl | CH₂CH₃ |
| IA-107 | Cl | CF₃ | CH₂CH₃ |
| IA-108 | Cl | OCH₃ | CH₂CH₃ |
| IA-109 | Cl | OCH₂CH₃ | CH₂CH₃ |
| IA-110 | Cl | OCH₂CF₃ | CH₂CH₃ |
| IA-111 | Cl | OCF₃ | CH₂CH₃ |
| IA-112 | Cl | OCFCF₂ | CH₂CH₃ |
| IA-113 | Cl | OCH₂CN | CH₂CH₃ |
| IA-114 | Cl | OCH₂CCH | CH₂CH₃ |
| IA-115 | Cl | OCH₂CH₂OCH₃ | CH₂CH₃ |
| IA-116 | Cl | OCH₂CH₂OCH₂CH₃ | CH₂CH₃ |
| IA-117 | Cl | SCH₃ | CH₂CH₃ |
| IA-118 | Cl | SCH₂CH₃ | CH₂CH₃ |
| IA-119 | Cl | SCF₃ | CH₂CH₃ |
| IA-120 | Cl | S(═O)CH₃ | CH₂CH₃ |
| IA-121 | Cl | S(═O)CH₂CH₃ | CH₂CH₃ |
| IA-122 | Cl | S(═O)CF₃ | CH₂CH₃ |
| IA-123 | Cl | S(═O)₂CH₃ | CH₂CH₃ |
| IA-124 | Cl | S(═O)₂CH₂CH₃ | CH₂CH₃ |
| IA-125 | Cl | S(═O)₂CF₃ | CH₂CH₃ |
| IA-126 | Cl | —O—S(═O)₂CH₃ | CH₂CH₃ |
| IA-127 | Cl | —O—S(═O)₂CH₂CH₃ | CH₂CH₃ |
| IA-128 | Cl | —OCH₂C(═O)OCH₃ | CH₂CH₃ |
| IA-129 | Cl | CH═N—OCH₃ | CH₂CH₃ |
| IA-130 | Cl | C(CF₃)═N—OCH₃ | CH₂CH₃ |
| IA-131 | CH₃ | Br | CH₂CH₃ |
| IA-132 | CH₃ | Cl | CH₂CH₃ |
| IA-133 | CH₃ | CF₃ | CH₂CH₃ |
| IA-134 | CH₃ | OCH₃ | CH₂CH₃ |
| IA-135 | CH₃ | OCH₂CH₃ | CH₂CH₃ |
| IA-136 | CH₃ | OCH₂CF₃ | CH₂CH₃ |
| IA-137 | CH₃ | OCF₃ | CH₂CH₃ |
| IA-138 | CH₃ | OCFCF₂ | CH₂CH₃ |
| IA-139 | CH₃ | OCH₂CN | CH₂CH₃ |
| IA-140 | CH₃ | OCH₂CCH | CH₂CH₃ |
| IA-141 | CH₃ | OCH₂CH₂OCH₃ | CH₂CH₃ |
| IA-142 | CH₃ | OCH₂CH₂OCH₂CH₃ | CH₂CH₃ |
| IA-143 | CH₃ | SCH₃ | CH₂CH₃ |
| IA-144 | CH₃ | SCH₂CH₃ | CH₂CH₃ |
| IA-145 | CH₃ | SCF₃ | CH₂CH₃ |
| IA-146 | CH₃ | S(═O)CH₃ | CH₂CH₃ |
| IA-147 | CH₃ | S(═O)CH₂CH₃ | CH₂CH₃ |
| IA-148 | CH₃ | S(═O)CF₃ | CH₂CH₃ |
| IA-149 | CH₃ | S(═O)₂CH₃ | CH₂CH₃ |
| IA-150 | CH₃ | S(═O)₂CH₂CH₃ | CH₂CH₃ |
| IA-151 | CH₃ | S(═O)₂CF₃ | CH₂CH₃ |
| IA-152 | CH₃ | —O—S(═O)₂CH₃ | CH₂CH₃ |
| IA-153 | CH₃ | —O—S(═O)₂CH₂CH₃ | CH₂CH₃ |
| IA-154 | CH₃ | —OCH₂C(═O)OCH₃ | CH₂CH₃ |
| IA-155 | CH₃ | CH═N—OCH₃ | CH₂CH₃ |
| IA-156 | CH₃ | C(CF₃)═N—OCH₃ | CH₂CH₃ |
| IA-157 | Cl | Br | CH(CH₃)₂ |
| IA-158 | Cl | Cl | CH(CH₃)₂ |
| IA-159 | Cl | CF₃ | CH(CH₃)₂ |
| IA-160 | Cl | OCH₃ | CH(CH₃)₂ |
| IA-161 | Cl | OCH₂CH₃ | CH(CH₃)₂ |
| IA-162 | Cl | OCH₂CF₃ | CH(CH₃)₂ |
| IA-163 | Cl | OCF₃ | CH(CH₃)₂ |
| IA-164 | Cl | OCFCF₂ | CH(CH₃)₂ |
| IA-165 | Cl | OCH₂CN | CH(CH₃)₂ |
| IA-166 | Cl | OCH₂CCH | CH(CH₃)₂ |
| IA-167 | Cl | OCH₂CH₂OCH₃ | CH(CH₃)₂ |
| IA-168 | Cl | OCH₂CH₂OCH₂CH₃ | CH(CH₃)₂ |
| IA-169 | Cl | SCH₃ | CH(CH₃)₂ |
| IA-170 | Cl | SCH₂CH₃ | CH(CH₃)₂ |
| IA-171 | Cl | SCF₃ | CH(CH₃)₂ |
| IA-172 | Cl | S(═O)CH₃ | CH(CH₃)₂ |
| IA-173 | Cl | S(═O)CH₂CH₃ | CH(CH₃)₂ |
| IA-174 | Cl | S(═O)CF₃ | CH(CH₃)₂ |
| IA-175 | Cl | S(═O)₂CH₃ | CH(CH₃)₂ |
| IA-176 | Cl | S(═O)₂CH₂CH₃ | CH(CH₃)₂ |
| IA-177 | Cl | S(═O)₂CF₃ | CH(CH₃)₂ |
| IA-178 | Cl | —O—S(═O)₂CH₃ | CH(CH₃)₂ |
| IA-179 | Cl | —O—S(═O)₂CH₂CH₃ | CH(CH₃)₂ |
| IA-180 | Cl | —OCH₂C(═O)OCH₃ | CH(CH₃)₂ |
| IA-181 | Cl | CH═N—OCH₃ | CH(CH₃)₂ |
| IA-182 | Cl | C(CF₃)═N—OCH₃ | CH(CH₃)₂ |
| IA-183 | CH₃ | Br | CH(CH₃)₂ |
| IA-184 | CH₃ | Cl | CH(CH₃)₂ |
| IA-185 | CH₃ | CF₃ | CH(CH₃)₂ |
| IA-186 | CH₃ | OCH₃ | CH(CH₃)₂ |
| IA-187 | CH₃ | OCH₂CH₃ | CH(CH₃)₂ |
| IA-188 | CH₃ | OCH₂CF₃ | CH(CH₃)₂ |
| IA-189 | CH₃ | OCF₃ | CH(CH₃)₂ |
| IA-190 | CH₃ | OCFCF₂ | CH(CH₃)₂ |
| IA-191 | CH₃ | OCH₂CN | CH(CH₃)₂ |
| IA-192 | CH₃ | OCH₂CCH | CH(CH₃)₂ |
| IA-193 | CH₃ | OCH₂CH₂OCH₃ | CH(CH₃)₂ |
| IA-194 | CH₃ | OCH₂CH₂OCH₂CH₃ | CH(CH₃)₂ |
| IA-195 | CH₃ | SCH₃ | CH(CH₃)₂ |
| IA-196 | CH₃ | SCH₂CH₃ | CH(CH₃)₂ |
| IA-197 | CH₃ | SCF₃ | CH(CH₃)₂ |
| IA-198 | CH₃ | S(═O)CH₃ | CH(CH₃)₂ |
| IA-199 | CH₃ | S(═O)CH₂CH₃ | CH(CH₃)₂ |
| IA-200 | CH₃ | S(═O)CF₃ | CH(CH₃)₂ |
| IA-201 | CH₃ | S(═O)₂CH₃ | CH(CH₃)₂ |
| IA-202 | CH₃ | S(═O)₂CH₂CH₃ | CH(CH₃)₂ |
| IA-203 | CH₃ | S(═O)₂CF₃ | CH(CH₃)₂ |
| IA-204 | CH₃ | —O—S(═O)₂CH₃ | CH(CH₃)₂ |
| IA-205 | CH₃ | —O—S(═O)₂CH₂CH₃ | CH(CH₃)₂ |
| IA-206 | CH₃ | —OCH₂C(═O)OCH₃ | CH(CH₃)₂ |
| IA-207 | CH₃ | CH═N—OCH₃ | CH(CH₃)₂ |
| IA-208 | CH₃ | C(CF₃)═N—OCH₃ | CH(CH₃)₂ |
| IA-209 | Cl | Br | C(CH₃)₃ |
| IA-210 | Cl | Cl | C(CH₃)₃ |
| IA-211 | Cl | CF₃ | C(CH₃)₃ |
| IA-212 | Cl | OCH₃ | C(CH₃)₃ |
| IA-213 | Cl | OCH₂CH₃ | C(CH₃)₃ |
| IA-214 | Cl | OCH₂CF₃ | C(CH₃)₃ |
| IA-215 | Cl | OCF₃ | C(CH₃)₃ |
| IA-216 | Cl | OCFCF₂ | C(CH₃)₃ |
| IA-217 | Cl | OCH₂CN | C(CH₃)₃ |
| IA-218 | Cl | OCH₂CCH | C(CH₃)₃ |
| IA-219 | Cl | OCH₂CH₂OCH₃ | C(CH₃)₃ |
| IA-220 | Cl | OCH₂CH₂OCH₂CH₃ | C(CH₃)₃ |
| IA-221 | Cl | SCH₃ | C(CH₃)₃ |
| IA-222 | Cl | SCH₂CH₃ | C(CH₃)₃ |
| IA-223 | Cl | SCF₃ | C(CH₃)₃ |
| IA-224 | Cl | S(═O)CH₃ | C(CH₃)₃ |
| IA-225 | Cl | S(═O)CH₂CH₃ | C(CH₃)₃ |
| IA-226 | Cl | S(═O)CF₃ | C(CH₃)₃ |
| IA-227 | Cl | S(═O)₂CH₃ | C(CH₃)₃ |
| IA-228 | Cl | S(═O)₂CH₂CH₃ | C(CH₃)₃ |
| IA-229 | Cl | S(═O)₂CF₃ | C(CH₃)₃ |
| IA-230 | Cl | —O—S(═O)₂CH₃ | C(CH₃)₃ |
| IA-231 | Cl | —O—S(═O)₂CH₂CH₃ | C(CH₃)₃ |
| IA-232 | Cl | —OCH₂C(═O)OCH₃ | C(CH₃)₃ |
| IA-233 | Cl | CH═N—OCH₃ | C(CH₃)₃ |
| IA-234 | Cl | C(CF₃)═N—OCH₃ | C(CH₃)₃ |
| IA-235 | CH₃ | Br | C(CH₃)₃ |
| IA-236 | CH₃ | Cl | C(CH₃)₃ |
| IA-237 | CH₃ | CF₃ | C(CH₃)₃ |
| IA-238 | CH₃ | OCH₃ | C(CH₃)₃ |
| IA-239 | CH₃ | OCH₂CH₃ | C(CH₃)₃ |
| IA-240 | CH₃ | OCH₂CF₃ | C(CH₃)₃ |
| IA-241 | CH₃ | OCF₃ | C(CH₃)₃ |
| IA-242 | CH₃ | OCFCF₂ | C(CH₃)₃ |
| IA-243 | CH₃ | OCH₂CN | C(CH₃)₃ |
| IA-244 | CH₃ | OCH₂CCH | C(CH₃)₃ |
| IA-245 | CH₃ | OCH₂CH₂OCH₃ | C(CH₃)₃ |
| IA-246 | CH₃ | OCH₂CH₂OCH₂CH₃ | C(CH₃)₃ |
| IA-247 | CH₃ | SCH₃ | C(CH₃)₃ |
| IA-248 | CH₃ | SCH₂CH₃ | C(CH₃)₃ |
| IA-249 | CH₃ | SCF₃ | C(CH₃)₃ |
| IA-250 | CH₃ | S(═O)CH₃ | C(CH₃)₃ |
| IA-251 | CH₃ | S(═O)CH₂CH₃ | C(CH₃)₃ |
| IA-252 | CH₃ | S(═O)CF₃ | C(CH₃)₃ |
| IA-253 | CH₃ | S(═O)₂CH₃ | C(CH₃)₃ |
| IA-254 | CH₃ | S(═O)₂CH₂CH₃ | C(CH₃)₃ |
| IA-255 | CH₃ | S(═O)₂CF₃ | C(CH₃)₃ |
| IA-256 | CH₃ | —O—S(═O)₂CH₃ | C(CH₃)₃ |
| IA-257 | CH₃ | —O—S(═O)₂CH₂CH₃ | C(CH₃)₃ |
| IA-258 | CH₃ | —OCH₂C(═O)OCH₃ | C(CH₃)₃ |
| IA-259 | CH₃ | CH═N—OCH₃ | C(CH₃)₃ |
| IA-260 | CH₃ | C(CF₃)═N—OCH₃ | C(CH₃)₃ |
| IA-261 | Cl | Br | CH₂CHCH₂ |
| IA-262 | Cl | Cl | CH₂CHCH₂ |
| IA-263 | Cl | CF₃ | CH₂CHCH₂ |
| IA-264 | Cl | OCH₃ | CH₂CHCH₂ |
| IA-265 | Cl | OCH₂CH₃ | CH₂CHCH₂ |
| IA-266 | Cl | OCH₂CF₃ | CH₂CHCH₂ |
| IA-267 | Cl | OCF₃ | CH₂CHCH₂ |
| IA-268 | Cl | OCFCF₂ | CH₂CHCH₂ |
| IA-269 | Cl | OCH₂CN | CH₂CHCH₂ |
| IA-270 | Cl | OCH₂CCH | CH₂CHCH₂ |
| IA-271 | Cl | OCH₂CH₂OCH₃ | CH₂CHCH₂ |
| IA-272 | Cl | OCH₂CH₂OCH₂CH₃ | CH₂CHCH₂ |
| IA-273 | Cl | SCH₃ | CH₂CHCH₂ |
| IA-274 | Cl | SCH₂CH₃ | CH₂CHCH₂ |
| IA-275 | Cl | SCF₃ | CH₂CHCH₂ |
| IA-276 | Cl | S(═O)CH₃ | CH₂CHCH₂ |
| IA-277 | Cl | S(═O)CH₂CH₃ | CH₂CHCH₂ |
| IA-278 | Cl | S(═O)CF₃ | CH₂CHCH₂ |
| IA-279 | Cl | S(═O)₂CH₃ | CH₂CHCH₂ |
| IA-280 | Cl | S(═O)₂CH₂CH₃ | CH₂CHCH₂ |
| IA-281 | Cl | S(═O)₂CF₃ | CH₂CHCH₂ |
| IA-282 | Cl | —O—S(═O)₂CH₃ | CH₂CHCH₂ |
| IA-283 | Cl | —O—S(═0)₂CH₂CH₃ | CH₂CHCH₂ |
| IA-284 | Cl | —OCH₂C(═O)OCH₃ | CH₂CHCH₂ |
| IA-285 | Cl | CH═N—OCH₃ | CH₂CHCH₂ |
| IA-286 | Cl | C(CF₃)═N—OCH₃ | CH₂CHCH₂ |
| IA-287 | CH₃ | Br | CH₂CHCH₂ |
| IA-288 | CH₃ | Cl | CH₂CHCH₂ |
| IA-289 | CH₃ | CF₃ | CH₂CHCH₂ |
| IA-290 | CH₃ | OCH₃ | CH₂CHCH₂ |
| IA-291 | CH₃ | OCH₂CH₃ | CH₂CHCH₂ |
| IA-292 | CH₃ | OCH₂CF₃ | CH₂CHCH₂ |
| IA-293 | CH₃ | OCF₃ | CH₂CHCH₂ |
| IA-294 | CH₃ | OCFCF₂ | CH₂CHCH₂ |
| IA-295 | CH₃ | OCH₂CN | CH₂CHCH₂ |
| IA-296 | CH₃ | OCH₂CCH | CH₂CHCH₂ |
| IA-297 | CH₃ | OCH₂CH₂OCH₃ | CH₂CHCH₂ |
| IA-298 | CH₃ | OCH₂CH₂OCH₂CH₃ | CH₂CHCH₂ |
| IA-299 | CH₃ | SCH₃ | CH₂CHCH₂ |
| IA-300 | CH₃ | SCH₂CH₃ | CH₂CHCH₂ |
| IA-301 | CH₃ | SCF₃ | CH₂CHCH₂ |
| IA-302 | CH₃ | S(═O)CH₃ | CH₂CHCH₂ |
| IA-303 | CH₃ | S(═O)CH₂CH₃ | CH₂CHCH₂ |
| IA-304 | CH₃ | S(═O)CF₃ | CH₂CHCH₂ |
| IA-305 | CH₃ | S(═O)₂CH₃ | CH₂CHCH₂ |
| IA-306 | CH₃ | S(═O)₂CH₂CH₃ | CH₂CHCH₂ |
| IA-307 | CH₃ | S(═O)₂CF₃ | CH₂CHCH₂ |
| IA-308 | CH₃ | —O—S(═O)₂CH₃ | CH₂CHCH₂ |
| IA-309 | CH₃ | —O—S(═O)₂CH₂CH₃ | CH₂CHCH₂ |
| IA-310 | CH₃ | —OCH₂C(═O)OCH₃ | CH₂CHCH₂ |
| IA-311 | CH₃ | CH═N—OCH₃ | CH₂CHCH₂ |
| IA-312 | CH₃ | C(CF₃)═N—OCH₃ | CH₂CHCH₂ |
| IA-313 | Cl | Br | CH₂CCH |
| IA-314 | Cl | Cl | CH₂CCH |
| IA-315 | Cl | CF₃ | CH₂CCH |
| IA-316 | Cl | OCH₃ | CH₂CCH |
| IA-317 | Cl | OCH₂CH₃ | CH₂CCH |
| IA-318 | Cl | OCH₂CF₃ | CH₂CCH |
| IA-319 | Cl | OCF₃ | CH₂CCH |
| IA-320 | Cl | OCFCF₂ | CH₂CCH |
| IA-321 | Cl | OCH₂CN | CH₂CCH |
| IA-322 | Cl | OCH₂CCH | CH₂CCH |
| IA-323 | Cl | OCH₂CH₂OCH₃ | CH₂CCH |
| IA-324 | Cl | OCH₂CH₂OCH₂CH₃ | CH₂CCH |
| IA-325 | Cl | SCH₃ | CH₂CCH |
| IA-326 | Cl | SCH₂CH₃ | CH₂CCH |
| IA-327 | Cl | SCF₃ | CH₂CCH |
| IA-328 | Cl | S(═O)CH₃ | CH₂CCH |
| IA-329 | Cl | S(═O)CH₂CH₃ | CH₂CCH |
| IA-330 | Cl | S(═O)CF₃ | CH₂CCH |
| IA-331 | Cl | S(═O)₂CH₃ | CH₂CCH |
| IA-332 | Cl | S(═O)₂CH₂CH₃ | CH₂CCH |
| IA-333 | Cl | S(═O)₂CF₃ | CH₂CCH |
| IA-334 | Cl | —O—S(═O)₂CH₃ | CH₂CCH |
| IA-335 | Cl | —O—S(═O)₂CH₂CH₃ | CH₂CCH |
| IA-336 | Cl | —OCH₂C(═O)OCH₃ | CH₂CCH |
| IA-337 | Cl | CH═N—OCH₃ | CH₂CCH |
| IA-338 | Cl | C(CF₃)═N—OCH₃ | CH₂CCH |
| IA-339 | CH₃ | Br | CH₂CCH |
| IA-340 | CH₃ | Cl | CH₂CCH |
| IA-341 | CH₃ | CF₃ | CH₂CCH |
| IA-342 | CH₃ | OCH₃ | CH₂CCH |
| IA-343 | CH₃ | OCH₂CH₃ | CH₂CCH |
| IA-344 | CH₃ | OCH₂CF₃ | CH₂CCH |
| IA-345 | CH₃ | OCF₃ | CH₂CCH |
| IA-346 | CH₃ | OCFCF₂ | CH₂CCH |
| IA-347 | CH₃ | OCH₂CN | CH₂CCH |
| IA-348 | CH₃ | OCH₂CCH | CH₂CCH |
| IA-349 | CH₃ | OCH₂CH₂OCH₃ | CH₂CCH |
| IA-350 | CH₃ | OCH₂CH₂OCH₂CH₃ | CH₂CCH |
| IA-351 | CH₃ | SCH₃ | CH₂CCH |
| IA-352 | CH₃ | SCH₂CH₃ | CH₂CCH |
| IA-353 | CH₃ | SCF₃ | CH₂CCH |
| IA-354 | CH₃ | S(═O)CH₃ | CH₂CCH |
| IA-355 | CH₃ | S(═O)CH₂CH₃ | CH₂CCH |
| IA-356 | CH₃ | S(═O)CF₃ | CH₂CCH |
| IA-357 | CH₃ | S(═O)₂CH₃ | CH₂CCH |
| IA-358 | CH₃ | S(═O)₂CH₂CH₃ | CH₂CCH |
| IA-359 | CH₃ | S(═O)₂CF₃ | CH₂CCH |
| IA-360 | CH₃ | —O—S(═O)₂CH₃ | CH₂CCH |
| IA-361 | CH₃ | —O—S(═O)₂CH₂CH₃ | CH₂CCH |
| IA-362 | CH₃ | CH═N—OCH₃ | CH₂CCH |
| IA-363 | CH₃ | C(CF₃)═N—OCH₃ | CH₂CCH |
| IA-364 | Cl | Br | CH₂CCH |
| IA-365 | Cl | Cl | CH₂CCH |
| IA-366 | Cl | CF₃ | CH₂CCH |
| IA-367 | Cl | OCH₃ | CH₂CCH |
| IA-368 | Cl | OCH₂CH₃ | CH₂CCH |
| IA-369 | Cl | OCH₂CF₃ | CH₂CCH |
| IA-370 | Cl | OCF₃ | CH₂CCH |
| IA-371 | Cl | OCFCF₂ | CH₂CCH |
| IA-372 | Cl | OCH₂CN | CH₂CCH |
| IA-373 | Cl | OCH₂CCH | CH₂CCH |
| IA-374 | Cl | OCH₂CH₂OCH₃ | CH₂CCH |
| IA-375 | Cl | OCH₂CH₂OCH₂CH₃ | CH₂CCH |
| IA-376 | Cl | SCH₃ | CH₂CCH |
| IA-377 | Cl | SCH₂CH₃ | CH₂CCH |
| IA-378 | Cl | SCF₃ | CH₂CCH |
| IA-379 | Cl | S(═O)CH₃ | CH₂CCH |
| IA-380 | Cl | S(═O)CH₂CH₃ | CH₂CCH |
| IA-381 | Cl | S(═O)CF₃ | CH₂CCH |
| IA-382 | Cl | S(═O)₂CH₃ | CH₂CCH |
| IA-383 | Cl | S(═O)₂CH₂CH₃ | CH₂CCH |
| IA-384 | Cl | S(═O)₂CF₃ | CH₂CCH |
| IA-385 | Cl | —O—S(═O)₂CH₃ | CH₂CCH |
| IA-386 | Cl | —O—S(═O)₂CH₂CH₃ | CH₂CCH |
| IA-387 | Cl | —OCH₂C(═O)OCH₃ | CH₂CCH |
| IA-388 | Cl | CH═N—OCH₃ | CH₂CCH |
| IA-389 | Cl | C(CF₃)═N—OCH₃ | CH₂CCH |
| IA-390 | CH₃ | Br | CH₂CCH |
| IA-391 | CH₃ | Cl | CH₂CCH |
| IA-392 | CH₃ | CF₃ | CH₂CCH |
| IA-393 | CH₃ | OCH₃ | CH₂CCH |
| IA-394 | CH₃ | OCH₂CH₃ | CH₂CCH |
| IA-395 | CH₃ | OCH₂CF₃ | CH₂CCH |
| IA-396 | CH₃ | OCF₃ | CH₂CCH |
| IA-397 | CH₃ | OCFCF₂ | CH₂CCH |
| IA-398 | CH₃ | OCH₂CN | CH₂CCH |
| IA-399 | CH₃ | OCH₂CCH | CH₂CCH |
| IA-400 | CH₃ | OCH₂CH₂OCH₃ | CH₂CCH |
| IA-401 | CH₃ | OCH₂CH₂OCH₂CH₃ | CH₂CCH |
| IA-402 | CH₃ | SCH₃ | CH₂CCH |
| IA-403 | CH₃ | SCH₂CH₃ | CH₂CCH |
| IA-404 | CH₃ | SCF₃ | CH₂CCH |
| IA-405 | CH₃ | S(═O)CH₃ | CH₂CCH |
| IA-406 | CH₃ | S(═O)CH₂CH₃ | CH₂CCH |
| IA-407 | CH₃ | S(═O)CF₃ | CH₂CCH |
| IA-408 | CH₃ | S(═O)₂CH₃ | CH₂CCH |
| IA-409 | CH₃ | S(═O)₂CH₂CH₃ | CH₂CCH |
| IA-410 | CH₃ | S(═O)₂CF₃ | CH₂CCH |
| IA-411 | CH₃ | —O—S(═O)₂CH₃ | CH₂CCH |
| IA-412 | CH₃ | —O—S(═O)₂CH₂CH₃ | CH₂CCH |
| IA-413 | CH₃ | —OCH₂C(═O)OCH₃ | CH₂CCH |
| IA-414 | CH₃ | —OCH₂C(═O)OCH₃ | CH₂CCH |
| IA-415 | CH₃ | CH═N—OCH₃ | CH₂CCH |
| IA-416 | CH₃ | C(CF₃)═N—OCH₃ | CH₂CCH |
| IA-417 | Cl | Br | CH₂CN |
| IA-418 | Cl | Cl | CH₂CN |
| IA-419 | Cl | CF₃ | CH₂CN |
| IA-420 | Cl | OCH₃ | CH₂CN |
| IA-421 | Cl | OCH₂CH₃ | CH₂CN |
| IA-422 | Cl | OCH₂CF₃ | CH₂CN |
| IA-423 | Cl | OCF₃ | CH₂CN |
| IA-424 | Cl | OCFCF₂ | CH₂CN |
| IA-425 | Cl | OCH₂CN | CH₂CN |
| IA-426 | Cl | OCH₂CCH | CH₂CN |
| IA-427 | Cl | OCH₂CH₂OCH₃ | CH₂CN |
| IA-428 | Cl | OCH₂CH₂OCH₂CH₃ | CH₂CN |
| IA-429 | Cl | SCH₃ | CH₂CN |
| IA-430 | Cl | SCH₂CH₃ | CH₂CN |
| IA-431 | Cl | SCF₃ | CH₂CN |
| IA-432 | Cl | S(═O)CH₃ | CH₂CN |
| IA-433 | Cl | S(═O)CH₂CH₃ | CH₂CN |
| IA-434 | Cl | S(═O)CF₃ | CH₂CN |
| IA-435 | Cl | S(═O)₂CH₃ | CH₂CN |
| IA-436 | Cl | S(═O)₂CH₂CH₃ | CH₂CN |
| IA-437 | Cl | S(═O)₂CF₃ | CH₂CN |
| IA-438 | Cl | —O—S(═O)₂CH₃ | CH₂CN |
| IA-439 | Cl | —O—S(═O)₂CH₂CH₃ | CH₂CN |
| IA-440 | Cl | —OCH₂C(═O)OCH₃ | CH₂CN |
| IA-441 | Cl | CH═N—OCH₃ | CH₂CN |
| IA-442 | Cl | C(CF₃)═N—OCH₃ | CH₂CN |
| IA-443 | CH₃ | Br | CH₂CN |
| IA-444 | CH₃ | Cl | CH₂CN |
| IA-445 | CH₃ | CF₃ | CH₂CN |
| IA-446 | CH₃ | OCH₃ | CH₂CN |
| IA-447 | CH₃ | OCH₂CH₃ | CH₂CN |
| IA-448 | CH₃ | OCH₂CF₃ | CH₂CN |
| IA-449 | CH₃ | OCF₃ | CH₂CN |
| IA-450 | CH₃ | OCFCF₂ | CH₂CN |
| IA-451 | CH₃ | OCH₂CN | CH₂CN |
| IA-452 | CH₃ | OCH₂CCH | CH₂CN |
| IA-453 | CH₃ | OCH₂CH₂OCH₃ | CH₂CN |
| IA-454 | CH₃ | OCH₂CH₂OCH₂CH₃ | CH₂CN |
| IA-455 | CH₃ | SCH₃ | CH₂CN |
| IA-456 | CH₃ | SCH₂CH₃ | CH₂CN |
| IA-457 | CH₃ | SCF₃ | CH₂CN |
| IA-458 | CH₃ | S(═O)CH₃ | CH₂CN |
| IA-459 | CH₃ | S(═O)CH₂CH₃ | CH₂CN |
| IA-460 | CH₃ | S(═O)CF₃ | CH₂CN |
| IA-461 | CH₃ | S(═O)₂CH₃ | CH₂CN |
| IA-462 | CH₃ | S(═O)₂CH₂CH₃ | CH₂CN |
| IA-463 | CH₃ | S(═O)₂CF₃ | CH₂CN |
| IA-464 | CH₃ | —O—S(═O)₂CH₃ | CH₂CN |
| IA-465 | CH₃ | —O—S(═O)₂CH₂CH₃ | CH₂CN |
| IA-466 | CH₃ | —OCH₂C(═O)OCH₃ | CH₂CN |
| IA-467 | CH₃ | CH═N—OCH₃ | CH₂CN |
| IA-468 | CH₃ | C(CF₃)═N—OCH₃ | CH₂CN |
| IA-469 | Cl | Br | CH₂C(═O)OCH₃ |
| IA-470 | Cl | Cl | CH₂C(═O)OCH₃ |
| IA-471 | Cl | CF₃ | CH₂C(═O)OCH₃ |
| IA-472 | Cl | OCH₃ | CH₂C(═O)OCH₃ |
| IA-473 | Cl | OCH₂CH₃ | CH₂C(═O)OCH₃ |
| IA-474 | Cl | OCH₂CF₃ | CH₂C(═O)OCH₃ |
| IA-475 | Cl | OCF₃ | CH₂C(═O)OCH₃ |
| IA-476 | Cl | OCFCF₂ | CH₂C(═O)OCH₃ |
| IA-477 | Cl | OCH₂CN | CH₂C(═O)OCH₃ |
| IA-478 | Cl | OCH₂CCH | CH₂C(═O)OCH₃ |
| IA-479 | Cl | OCH₂CH₂OCH₃ | CH₂C(═O)OCH₃ |
| IA-480 | Cl | OCH₂CH₂OCH₂CH₃ | CH₂C(═O)OCH₃ |
| IA-481 | Cl | SCH₃ | CH₂C(═O)OCH₃ |
| IA-482 | Cl | SCH₂CH₃ | CH₂C(═O)OCH₃ |
| IA-483 | Cl | SCF₃ | CH₂C(═O)OCH₃ |
| IA-484 | Cl | S(═O)CH₃ | CH₂C(═O)OCH₃ |
| IA-485 | Cl | S(═O)CH₂CH₃ | CH₂C(═O)OCH₃ |
| IA-486 | Cl | S(═O)CF₃ | CH₂C(═O)OCH₃ |
| IA-487 | Cl | S(═O)₂CH₃ | CH₂C(═O)OCH₃ |
| IA-488 | Cl | S(═O)₂CH₂CH₃ | CH₂C(═O)OCH₃ |
| IA-489 | Cl | S(═O)₂CF₃ | CH₂C(═O)OCH₃ |
| IA-490 | Cl | —O—S(═O)₂CH₃ | CH₂C(═O)OCH₃ |
| IA-491 | Cl | —O—S(═O)₂CH₂CH₃ | CH₂C(═O)OCH₃ |
| IA-492 | Cl | —OCH₂C(═O)OCH₃ | CH₂C(═O)OCH₃ |
| IA-493 | Cl | CH═N—OCH₃ | CH₂C(═O)OCH₃ |
| IA-494 | Cl | C(CF₃)═N—OCH₃ | CH₂C(═O)OCH₃ |
| IA-495 | CH₃ | Br | CH₂C(═O)OCH₃ |
| IA-496 | CH₃ | Cl | CH₂C(═O)OCH₃ |
| IA-497 | CH₃ | CF₃ | CH₂C(═O)OCH₃ |
| IA-498 | CH₃ | OCH₃ | CH₂C(═O)OCH₃ |
| IA-499 | CH₃ | OCH₂CH₃ | CH₂C(═O)OCH₃ |
| IA-500 | CH₃ | OCH₂CF₃ | CH₂C(═O)OCH₃ |
| IA-501 | CH₃ | OCF₃ | CH₂C(═O)OCH₃ |
| IA-502 | CH₃ | OCFCF₂ | CH₂C(═O)OCH₃ |
| IA-503 | CH₃ | OCH₂CN | CH₂C(═O)OCH₃ |
| IA-504 | CH₃ | OCH₂CCH | CH₂C(═O)OCH₃ |
| IA-505 | CH₃ | OCH₂CH₂OCH₃ | CH₂C(═O)OCH₃ |
| IA-506 | CH₃ | OCH₂CH₂OCH₂CH₃ | CH₂C(═O)OCH₃ |
| IA-507 | CH₃ | SCH₃ | CH₂C(═O)OCH₃ |
| IA-508 | CH₃ | SCH₂CH₃ | CH₂C(═O)OCH₃ |
| IA-509 | CH₃ | SCF₃ | CH₂C(═O)OCH₃ |
| IA-510 | CH₃ | S(═O)CH₃ | CH₂C(═O)OCH₃ |
| IA-511 | CH₃ | S(═O)CH₂CH₃ | CH₂C(═O)OCH₃ |
| IA-512 | CH₃ | S(═O)CF₃ | CH₂C(═O)OCH₃ |
| IA-513 | CH₃ | S(═O)₂CH₃ | CH₂C(═O)OCH₃ |
| IA-514 | CH₃ | S(═O)₂CH₂CH₃ | CH₂C(═O)OCH₃ |
| IA-515 | CH₃ | S(═O)₂CF₃ | CH₂C(═O)OCH₃ |
| IA-516 | CH₃ | —O—S(═O)₂CH₃ | CH₂C(═O)OCH₃ |
| IA-517 | CH₃ | —O—S(═O)₂CH₂CH₃ | CH₂C(═O)OCH₃ |
| IA-518 | CH₃ | —OCH₂C(═O)OCH₃ | CH₂C(═O)OCH₃ |
| IA-519 | CH₃ | CH═N—OCH₃ | CH₂C(═O)OCH₃ |
| IA-520 | CH₃ | C(CF₃)═N—OCH₃ | CH₂C(═O)OCH₃ |

With regard to their use in the pesticidal mixtures of the present invention, the compounds II of group A.3 as defined above, especially beta-cyfluthrin, alpha-cypermethrin, deltamethrin, fenvalerate and lambda-cyhalothrin, are especially preferred.

Especially preferred are pesticidal mixtures containing alpha-cypermethrin as compound II.

With regard to their use in the pesticidal mixtures of the present invention, the compounds II of group A.4 as defined above, especially flufenoxuron, etoxazole, tebufenozide, pyriproxyfen, fenoxycarb, spirodiclofen, spiromesifen and spirotetramat are especially preferred.

Especially preferred are pesticidal mixtures containing spirodiclofen, spiromesifen and spirotetramat as compound(s) II.

With regard to their use in the pesticidal mixtures of the present invention, the compounds II of group A.5 as defined above, are especially preferred.

Especially preferred are pesticidal mixtures containing clothianidine as compound II.

Especially preferred are pesticidal mixtures containing dinetofuran as compound II.

Especially preferred are pesticidal mixtures containing imidacloprid as compound II.

Especially preferred are pesticidal mixtures containing thiamethoxam as compound II.

Especially preferred are pesticidal mixtures containing nitenpyram as compound II.

Especially preferred are pesticidal mixtures containing acetamiprid as compound II.

Especially preferred are pesticidal mixtures containing thiacloprid as compound II.

With regard to their use in the pesticidal mixtures of the present invention, the compounds II of group A.6 as defined above, especially endosulfan and fipronil, most preferably fipronil, are especially preferred.

With regard to their use in the pesticidal mixtures of the present invention, the compounds II of group A.7 as defined above, especially abamectin, are especially preferred.

With regard to their use in the pesticidal mixtures of the present invention, the compounds II of group A.8 as defined above, especially fenazaquin, pyridaben and tebufenpyrad are especially preferred.

With regard to their use in the pesticidal mixtures of the present invention, the compounds II of group A.11 as defined above, especially diafenthiuron and propargite are especially preferred.

With regard to their use in the pesticidal mixtures of the present invention, the compounds II of group A.13 as defined above, especially indoxacarb and metaflumizone, are especially preferred.

Moreover, with regard to its use in the pesticidal mixtures of the present invention, indoxacarb is especially preferred.

Moreover, with regard to its use in the pesticidal mixtures of the present invention, metaflumizone is especially preferred.

With regard to their use in the pesticidal mixtures of the present invention, the compounds II of group A.14 as defined above, especially flonicamid and pyridalyl, are especially preferred.

Moreover, with regard to its use in the pesticidal mixtures of the present invention, flonicamid is especially preferred.

Moreover, with regard to its use in the pesticidal mixtures of the present invention, pyridalyl is especially preferred.

Especially preferred are the inventive mixtures wherein the compound II of group A is alpha-cypermethrin and the compound of formula I is a compound of Table 1.

Especially preferred are the inventive mixtures wherein the compound II of group A is alpha-cypermethrin and the compound of formula I is a compound of Table 2.

Especially preferred are the inventive mixtures wherein the compound II of group A is alpha-cypermethrin and the compound of formula I is a compound of Table 3.

Especially preferred are the inventive mixtures wherein the compound II of group A is alpha-cypermethrin and the compound of formula I is a compound of Table 4.

Especially preferred are the inventive mixtures wherein the compound II of group A is alpha-cypermethrin and the compound of formula I is a compound of Table 8.

Especially preferred are the inventive mixtures wherein the compound II of group A is alpha-cypermethrin and the compound of formula I is a compound of Table 10.

Especially preferred are the inventive mixtures wherein the compound II of group A is alpha-cypermethrin and the compound of formula I is a compound of Table 11.

Especially preferred are the inventive mixtures wherein the compound II of group A is alpha-cypermethrin and the compound of formula I is a compound of Table 12.

Especially preferred are the inventive mixtures wherein the compound II of group A is alpha-cypermethrin and the compound of formula I is a compound of Table 13.

Especially preferred are the inventive mixtures wherein the compound II of group A is alpha-cypermethrin and the compound of formula I is a compound of Table 14.

Especially preferred are the inventive mixtures wherein the compound II of group A is alpha-cypermethrin and the compound of formula I is a compound of Table 15.

Especially preferred are the inventive mixtures wherein the compound II of group A is alpha-cypermethrin and the compound of formula I is a compound of Table 19.

Especially preferred are the inventive mixtures wherein the compound II of group A is alpha-cypermethrin and the compound of formula I is a compound of Table 21.

Especially preferred are the inventive mixtures wherein the compound II of group A is alpha-cypermethrin and the compound of formula I is a compound of Table 22.

Especially preferred are the inventive mixtures wherein the compound II of group A is spirodiclofen and the compound of formula I is a compound of Table 1.

Especially preferred are the inventive mixtures wherein the compound II of group A is spirodiclofen and the compound of formula I is a compound of Table 2.

Especially preferred are the inventive mixtures wherein the compound II of group A is spirodiclofen and the compound of formula I is a compound of Table 3.

Especially preferred are the inventive mixtures wherein the compound II of group A is spirodiclofen and the compound of formula I is a compound of Table 4.

Especially preferred are the inventive mixtures wherein the compound II of group A is spirodiclofen and the compound of formula I is a compound of Table 8.

Especially preferred are the inventive mixtures wherein the compound II of group A is spirodiclofen and the compound of formula I is a compound of Table 10.

Especially preferred are the inventive mixtures wherein the compound II of group A is spirodiclofen and the compound of formula I is a compound of Table 11.

Especially preferred are the inventive mixtures wherein the compound II of group A is spirodiclofen and the compound of formula I is a compound of Table 12.

Especially preferred are the inventive mixtures wherein the compound II of group A is spirodiclofen and the compound of formula I is a compound of Table 13.

Especially preferred are the inventive mixtures wherein the compound II of group A is spirodiclofen and the compound of formula I is a compound of Table 14.

Especially preferred are the inventive mixtures wherein the compound II of group A is spirodiclofen and the compound of formula I is a compound of Table 15.

Especially preferred are the inventive mixtures wherein the compound II of group A is spirodiclofen and the compound of formula I is a compound of Table 19.

Especially preferred are the inventive mixtures wherein the compound II of group A is spirodiclofen and the compound of formula I is a compound of Table 21.

Especially preferred are the inventive mixtures wherein the compound II of group A is spirodiclofen and the compound of formula I is a compound of Table 22.

Especially preferred are the inventive mixtures wherein the compound II of group A is spiromesifen and the compound of formula I is a compound of Table 1.

Especially preferred are the inventive mixtures wherein the compound II of group A is spiromesifen and the compound of formula I is a compound of Table 2.

Especially preferred are the inventive mixtures wherein the compound II of group A is spiromesifen and the compound of formula I is a compound of Table 3.

Especially preferred are the inventive mixtures wherein the compound II of group A is spiromesifen and the compound of formula I is a compound of Table 4.

Especially preferred are the inventive mixtures wherein the compound II of group A is spiromesifen and the compound of formula I is a compound of Table 8.

Especially preferred are the inventive mixtures wherein the compound II of group A is spiromesifen and the compound of formula I is a compound of Table 10.

Especially preferred are the inventive mixtures wherein the compound II of group A is spiromesifen and the compound of formula I is a compound of Table 11.

Especially preferred are the inventive mixtures wherein the compound II of group A is spiromesifen and the compound of formula I is a compound of Table 12.

Especially preferred are the inventive mixtures wherein the compound II of group A is spiromesifen and the compound of formula I is a compound of Table 13.

Especially preferred are the inventive mixtures wherein the compound II of group A is spiromesifen and the compound of formula I is a compound of Table 14.

Especially preferred are the inventive mixtures wherein the compound II of group A is spiromesifen and the compound of formula I is a compound of Table 15.

Especially preferred are the inventive mixtures wherein the compound II of group A is spiromesifen and the compound of formula I is a compound of Table 19.

Especially preferred are the inventive mixtures wherein the compound II of group A is spiromesifen and the compound of formula I is a compound of Table 21.

Especially preferred are the inventive mixtures wherein the compound II of group A is spiromesifen and the compound of formula I is a compound of Table 22.

Especially preferred are the inventive mixtures wherein the compound II of group A is spirotetramat and the compound of formula I is a compound of Table 1.

Especially preferred are the inventive mixtures wherein the compound II of group A is spirotetramat and the compound of formula I is a compound of Table 2.

Especially preferred are the inventive mixtures wherein the compound II of group A is spirotetramat and the compound of formula I is a compound of Table 3.

Especially preferred are the inventive mixtures wherein the compound II of group A is spirotetramat and the compound of formula I is a compound of Table 4.

Especially preferred are the inventive mixtures wherein the compound II of group A is spirotetramat and the compound of formula I is a compound of Table 8.

Especially preferred are the inventive mixtures wherein the compound II of group A is spirotetramat and the compound of formula I is a compound of Table 10.

Especially preferred are the inventive mixtures wherein the compound II of group A is spirotetramat and the compound of formula I is a compound of Table 11.

Especially preferred are the inventive mixtures wherein the compound II of group A is spirotetramat and the compound of formula I is a compound of Table 12.

Especially preferred are the inventive mixtures wherein the compound II of group A is spirotetramat and the compound of formula I is a compound of Table 13.

Especially preferred are the inventive mixtures wherein the compound II of group A is spirotetramat and the compound of formula I is a compound of Table 14.

Especially preferred are the inventive mixtures wherein the compound II of group A is spirotetramat and the compound of formula I is a compound of Table 15.

Especially preferred are the inventive mixtures wherein the compound II of group A is spirotetramat and the compound of formula I is a compound of Table 19.

Especially preferred are the inventive mixtures wherein the compound II of group A is spirotetramat and the compound of formula I is a compound of Table 21.

Especially preferred are the inventive mixtures wherein the compound II of group A is spirotetramat and the compound of formula I is a compound of Table 22.

Especially preferred are the inventive mixtures wherein the compound II of group A is clothianidine and the compound of formula I is a compound of Table 1.

Especially preferred are the inventive mixtures wherein the compound II of group A is clothianidine and the compound of formula I is a compound of Table 2.

Especially preferred are the inventive mixtures wherein the compound II of group A is clothianidine and the compound of formula I is a compound of Table 3.

Especially preferred are the inventive mixtures wherein the compound II of group A is clothianidine and the compound of formula I is a compound of Table 4.

Especially preferred are the inventive mixtures wherein the compound II of group A is clothianidine and the compound of formula I is a compound of Table 8.

Especially preferred are the inventive mixtures wherein the compound II of group A is clothianidine and the compound of formula I is a compound of Table 10.

Especially preferred are the inventive mixtures wherein the compound II of group A is clothianidine and the compound of formula I is a compound of Table 11.

Especially preferred are the inventive mixtures wherein the compound II of group A is clothianidine and the compound of formula I is a compound of Table 12.

Especially preferred are the inventive mixtures wherein the compound II of group A is clothianidine and the compound of formula I is a compound of Table 13.

Especially preferred are the inventive mixtures wherein the compound II of group A is clothianidine and the compound of formula I is a compound of Table 14.

Especially preferred are the inventive mixtures wherein the compound II of group A is clothianidine and the compound of formula I is a compound of Table 15.

Especially preferred are the inventive mixtures wherein the compound II of group A is clothianidine and the compound of formula I is a compound of Table 19.

Especially preferred are the inventive mixtures wherein the compound II of group A is clothianidine and the compound of formula I is a compound of Table 21.

Especially preferred are the inventive mixtures wherein the compound II of group A is clothianidine and the compound of formula I is a compound of Table 22.

Especially preferred are the inventive mixtures wherein the compound II of group A is dinetofuran and the compound of formula I is a compound of Table 1.

Especially preferred are the inventive mixtures wherein the compound II of group A is dinetofuran and the compound of formula I is a compound of Table 2.

Especially preferred are the inventive mixtures wherein the compound II of group A is dinetofuran and the compound of formula I is a compound of Table 3.

Especially preferred are the inventive mixtures wherein the compound II of group A is dinetofuran and the compound of formula I is a compound of Table 4.

Especially preferred are the inventive mixtures wherein the compound II of group A is dinetofuran and the compound of formula I is a compound of Table 8.

Especially preferred are the inventive mixtures wherein the compound II of group A is dinetofuran and the compound of formula I is a compound of Table 10.

Especially preferred are the inventive mixtures wherein the compound II of group A is dinetofuran and the compound of formula I is a compound of Table 11.

Especially preferred are the inventive mixtures wherein the compound II of group A is dinetofuran and the compound of formula I is a compound of Table 12.

Especially preferred are the inventive mixtures wherein the compound II of group A is dinetofuran and the compound of formula I is a compound of Table 13.

Especially preferred are the inventive mixtures wherein the compound II of group A is dinetofuran and the compound of formula I is a compound of Table 14.

Especially preferred are the inventive mixtures wherein the compound II of group A is dinetofuran and the compound of formula I is a compound of Table 15.

Especially preferred are the inventive mixtures wherein the compound II of group A is dinetofuran and the compound of formula I is a compound of Table 19.

Especially preferred are the inventive mixtures wherein the compound II of group A is dinetofuran and the compound of formula I is a compound of Table 21.

Especially preferred are the inventive mixtures wherein the compound II of group A is dinetofuran and the compound of formula I is a compound of Table 22.

Especially preferred are the inventive mixtures wherein the compound II of group A is imidacloprid and the compound of formula I is a compound of Table 1.

Especially preferred are the inventive mixtures wherein the compound II of group A is imidacloprid and the compound of formula I is a compound of Table 2.

Especially preferred are the inventive mixtures wherein the compound II of group A is imidacloprid and the compound of formula I is a compound of Table 3.

Especially preferred are the inventive mixtures wherein the compound II of group A is imidacloprid and the compound of formula I is a compound of Table 4.

Especially preferred are the inventive mixtures wherein the compound II of group A is imidacloprid and the compound of formula I is a compound of Table 8.

Especially preferred are the inventive mixtures wherein the compound II of group A is imidacloprid and the compound of formula I is a compound of Table 10.

Especially preferred are the inventive mixtures wherein the compound II of group A is imidacloprid and the compound of formula I is a compound of Table 11.

Especially preferred are the inventive mixtures wherein the compound II of group A is imidacloprid and the compound of formula I is a compound of Table 12.

Especially preferred are the inventive mixtures wherein the compound II of group A is imidacloprid and the compound of formula I is a compound of Table 13.

Especially preferred are the inventive mixtures wherein the compound II of group A is imidacloprid and the compound of formula I is a compound of Table 14.

Especially preferred are the inventive mixtures wherein the compound II of group A is imidacloprid and the compound of formula I is a compound of Table 15.

Especially preferred are the inventive mixtures wherein the compound II of group A is imidacloprid and the compound of formula I is a compound of Table 19.

Especially preferred are the inventive mixtures wherein the compound II of group A is imidacloprid and the compound of formula I is a compound of Table 21.

Especially preferred are the inventive mixtures wherein the compound II of group A is imidacloprid and the compound of formula I is a compound of Table 22.

Especially preferred are the inventive mixtures wherein the compound II of group A is thiamethoxam and the compound of formula I is a compound of Table 1.

Especially preferred are the inventive mixtures wherein the compound II of group A is thiamethoxam and the compound of formula I is a compound of Table 2.

Especially preferred are the inventive mixtures wherein the compound II of group A is thiamethoxam and the compound of formula I is a compound of Table 3.

Especially preferred are the inventive mixtures wherein the compound II of group A is thiamethoxam and the compound of formula I is a compound of Table 4.

Especially preferred are the inventive mixtures wherein the compound II of group A is thiamethoxam and the compound of formula I is a compound of Table 8.

Especially preferred are the inventive mixtures wherein the compound II of group A is thiamethoxam and the compound of formula I is a compound of Table 10.

Especially preferred are the inventive mixtures wherein the compound II of group A is thiamethoxam and the compound of formula I is a compound of Table 11.

Especially preferred are the inventive mixtures wherein the compound II of group A is thiamethoxam and the compound of formula I is a compound of Table 12.

Especially preferred are the inventive mixtures wherein the compound II of group A is thiamethoxam and the compound of formula I is a compound of Table 13.

Especially preferred are the inventive mixtures wherein the compound II of group A is thiamethoxam and the compound of formula I is a compound of Table 14.

Especially preferred are the inventive mixtures wherein the compound II of group A is thiamethoxam and the compound of formula I is a compound of Table 15.

Especially preferred are the inventive mixtures wherein the compound II of group A is thiamethoxam and the compound of formula I is a compound of Table 19.

Especially preferred are the inventive mixtures wherein the compound II of group A is thiamethoxam and the compound of formula I is a compound of Table 21.

Especially preferred are the inventive mixtures wherein the compound II of group A is thiamethoxam and the compound of formula I is a compound of Table 22.

Especially preferred are the inventive mixtures wherein the compound II of group A is nitenpyram and the compound of formula I is a compound of Table 1.

Especially preferred are the inventive mixtures wherein the compound II of group A is nitenpyram and the compound of formula I is a compound of Table 2.

Especially preferred are the inventive mixtures wherein the compound II of group A is nitenpyram and the compound of formula I is a compound of Table 3.

Especially preferred are the inventive mixtures wherein the compound II of group A is nitenpyram and the compound of formula I is a compound of Table 4.

Especially preferred are the inventive mixtures wherein the compound II of group A is nitenpyram and the compound of formula I is a compound of Table 8.

Especially preferred are the inventive mixtures wherein the compound II of group A is nitenpyram and the compound of formula I is a compound of Table 10.

Especially preferred are the inventive mixtures wherein the compound II of group A is nitenpyram and the compound of formula I is a compound of Table 11.

Especially preferred are the inventive mixtures wherein the compound II of group A is nitenpyram and the compound of formula I is a compound of Table 12.

Especially preferred are the inventive mixtures wherein the compound II of group A is nitenpyram and the compound of formula I is a compound of Table 13.

Especially preferred are the inventive mixtures wherein the compound II of group A is nitenpyram and the compound of formula I is a compound of Table 14.

Especially preferred are the inventive mixtures wherein the compound II of group A is nitenpyram and the compound of formula I is a compound of Table 15.

Especially preferred are the inventive mixtures wherein the compound II of group A is nitenpyram and the compound of formula I is a compound of Table 19.

Especially preferred are the inventive mixtures wherein the compound II of group A is nitenpyram and the compound of formula I is a compound of Table 21.

Especially preferred are the inventive mixtures wherein the compound II of group A is nitenpyram and the compound of formula I is a compound of Table 22.

Especially preferred are the inventive mixtures wherein the compound II of group A is acetamiprid and the compound of formula I is a compound of Table 1.

Especially preferred are the inventive mixtures wherein the compound II of group A is acetamiprid and the compound of formula I is a compound of Table 2.

Especially preferred are the inventive mixtures wherein the compound II of group A is acetamiprid and the compound of formula I is a compound of Table 3.

Especially preferred are the inventive mixtures wherein the compound II of group A is acetamiprid and the compound of formula I is a compound of Table 4.

Especially preferred are the inventive mixtures wherein the compound II of group A is acetamiprid and the compound of formula I is a compound of Table 8.

Especially preferred are the inventive mixtures wherein the compound II of group A is acetamiprid and the compound of formula I is a compound of Table 10.

Especially preferred are the inventive mixtures wherein the compound II of group A is acetamiprid and the compound of formula I is a compound of Table 11.

Especially preferred are the inventive mixtures wherein the compound II of group A is acetamiprid and the compound of formula I is a compound of Table 12.

Especially preferred are the inventive mixtures wherein the compound II of group A is acetamiprid and the compound of formula I is a compound of Table 13.

Especially preferred are the inventive mixtures wherein the compound II of group A is acetamiprid and the compound of formula I is a compound of Table 14.

Especially preferred are the inventive mixtures wherein the compound II of group A is acetamiprid and the compound of formula I is a compound of Table 15.

Especially preferred are the inventive mixtures wherein the compound II of group A is acetamiprid and the compound of formula I is a compound of Table 19.

Especially preferred are the inventive mixtures wherein the compound II of group A is acetamiprid and the compound of formula I is a compound of Table 21.

Especially preferred are the inventive mixtures wherein the compound II of group A is acetamiprid and the compound of formula I is a compound of Table 22.

Especially preferred are the inventive mixtures wherein the compound II of group A is thiacloprid and the compound of formula I is a compound of Table 1.

Especially preferred are the inventive mixtures wherein the compound II of group A is thiacloprid and the compound of formula I is a compound of Table 2.

Especially preferred are the inventive mixtures wherein the compound II of group A is thiacloprid and the compound of formula I is a compound of Table 3.

Especially preferred are the inventive mixtures wherein the compound II of group A is thiacloprid and the compound of formula I is a compound of Table 4.

Especially preferred are the inventive mixtures wherein the compound II of group A is thiacloprid and the compound of formula I is a compound of Table 8.

Especially preferred are the inventive mixtures wherein the compound II of group A is thiacloprid and the compound of formula I is a compound of Table 10.

Especially preferred are the inventive mixtures wherein the compound II of group A is thiacloprid and the compound of formula I is a compound of Table 11.

Especially preferred are the inventive mixtures wherein the compound II of group A is thiacloprid and the compound of formula I is a compound of Table 12.

Especially preferred are the inventive mixtures wherein the compound II of group A is thiacloprid and the compound of formula I is a compound of Table 13.

Especially preferred are the inventive mixtures wherein the compound II of group A is thiacloprid and the compound of formula I is a compound of Table 14.

Especially preferred are the inventive mixtures wherein the compound II of group A is thiacloprid and the compound of formula I is a compound of Table 15.

Especially preferred are the inventive mixtures wherein the compound II of group A is thiacloprid and the compound of formula I is a compound of Table 19.

Especially preferred are the inventive mixtures wherein the compound II of group A is thiacloprid and the compound of formula I is a compound of Table 21.

Especially preferred are the inventive mixtures wherein the compound II of group A is thiacloprid and the compound of formula I is a compound of Table 22.

Especially preferred are the inventive mixtures wherein the compound II of group A is endosulfan and the compound of formula I is a compound of Table 1.

Especially preferred are the inventive mixtures wherein the compound II of group A is endosulfan and the compound of formula I is a compound of Table 2.

Especially preferred are the inventive mixtures wherein the compound II of group A is endosulfan and the compound of formula I is a compound of Table 3.

Especially preferred are the inventive mixtures wherein the compound II of group A is endosulfan and the compound of formula I is a compound of Table 4.

Especially preferred are the inventive mixtures wherein the compound II of group A is endosulfan and the compound of formula I is a compound of Table 8.

Especially preferred are the inventive mixtures wherein the compound II of group A is endosulfan and the compound of formula I is a compound of Table 10.

Especially preferred are the inventive mixtures wherein the compound II of group A is endosulfan and the compound of formula I is a compound of Table 11.

Especially preferred are the inventive mixtures wherein the compound II of group A is endosulfan and the compound of formula I is a compound of Table 12.

Especially preferred are the inventive mixtures wherein the compound II of group A is endosulfan and the compound of formula I is a compound of Table 13.

Especially preferred are the inventive mixtures wherein the compound II of group A is endosulfan and the compound of formula I is a compound of Table 14.

Especially preferred are the inventive mixtures wherein the compound II of group A is endosulfan and the compound of formula I is a compound of Table 15.

Especially preferred are the inventive mixtures wherein the compound II of group A is endosulfan and the compound of formula I is a compound of Table 19.

Especially preferred are the inventive mixtures wherein the compound II of group A is endosulfan and the compound of formula I is a compound of Table 21.

Especially preferred are the inventive mixtures wherein the compound II of group A is endosulfan and the compound of formula I is a compound of Table 22.

Especially preferred are the inventive mixtures wherein the compound II of group A is fipronil and the compound of formula I is a compound of Table 1.

Especially preferred are the inventive mixtures wherein the compound II of group A is fipronil and the compound of formula I is a compound of Table 2.

Especially preferred are the inventive mixtures wherein the compound II of group A is fipronil and the compound of formula I is a compound of Table 3.

Especially preferred are the inventive mixtures wherein the compound II of group A is fipronil and the compound of formula I is a compound of Table 4.

Especially preferred are the inventive mixtures wherein the compound II of group A is fipronil and the compound of formula I is a compound of Table 8.

Especially preferred are the inventive mixtures wherein the compound II of group A is fipronil and the compound of formula I is a compound of Table 10.

Especially preferred are the inventive mixtures wherein the compound II of group A is fipronil and the compound of formula I is a compound of Table 11.

Especially preferred are the inventive mixtures wherein the compound II of group A is fipronil and the compound of formula I is a compound of Table 12.

Especially preferred are the inventive mixtures wherein the compound II of group A is fipronil and the compound of formula I is a compound of Table 13.

Especially preferred are the inventive mixtures wherein the compound II of group A is fipronil and the compound of formula I is a compound of Table 14.

Especially preferred are the inventive mixtures wherein the compound II of group A is fipronil and the compound of formula I is a compound of Table 15.

Especially preferred are the inventive mixtures wherein the compound II of group A is fipronil and the compound of formula I is a compound of Table 19.

Especially preferred are the inventive mixtures wherein the compound II of group A is fipronil and the compound of formula I is a compound of Table 21.

Especially preferred are the inventive mixtures wherein the compound II of group A is fipronil and the compound of formula I is a compound of Table 22.

Especially preferred are the inventive mixtures wherein the compound II of group A is abamectin and the compound of formula I is a compound of Table 1.

Especially preferred are the inventive mixtures wherein the compound II of group A is abamectin and the compound of formula I is a compound of Table 2.

Especially preferred are the inventive mixtures wherein the compound II of group A is abamectin and the compound of formula I is a compound of Table 3.

Especially preferred are the inventive mixtures wherein the compound II of group A is abamectin and the compound of formula I is a compound of Table 4.

Especially preferred are the inventive mixtures wherein the compound II of group A is abamectin and the compound of formula I is a compound of Table 8.

Especially preferred are the inventive mixtures wherein the compound II of group A is abamectin and the compound of formula I is a compound of Table 10.

Especially preferred are the inventive mixtures wherein the compound II of group A is abamectin and the compound of formula I is a compound of Table 11.

Especially preferred are the inventive mixtures wherein the compound II of group A is abamectin and the compound of formula I is a compound of Table 12.

Especially preferred are the inventive mixtures wherein the compound II of group A is abamectin and the compound of formula I is a compound of Table 13.

Especially preferred are the inventive mixtures wherein the compound II of group A is abamectin and the compound of formula I is a compound of Table 14.

Especially preferred are the inventive mixtures wherein the compound II of group A is abamectin and the compound of formula I is a compound of Table 15.

Especially preferred are the inventive mixtures wherein the compound II of group A is abamectin and the compound of formula I is a compound of Table 19.

Especially preferred are the inventive mixtures wherein the compound II of group A is abamectin and the compound of formula I is a compound of Table 21.

Especially preferred are the inventive mixtures wherein the compound II of group A is abamectin and the compound of formula I is a compound of Table 22.

Especially preferred are the inventive mixtures wherein the compound II of group A is fenazaquin and the compound of formula I is a compound of Table 1.

Especially preferred are the inventive mixtures wherein the compound II of group A is fenazaquin and the compound of formula I is a compound of Table 2.

Especially preferred are the inventive mixtures wherein the compound II of group A is fenazaquin and the compound of formula I is a compound of Table 3.

Especially preferred are the inventive mixtures wherein the compound II of group A is fenazaquin and the compound of formula I is a compound of Table 4.

Especially preferred are the inventive mixtures wherein the compound II of group A is fenazaquin and the compound of formula I is a compound of Table 8.

Especially preferred are the inventive mixtures wherein the compound II of group A is fenazaquin and the compound of formula I is a compound of Table 10.

Especially preferred are the inventive mixtures wherein the compound II of group A is fenazaquin and the compound of formula I is a compound of Table 11.

Especially preferred are the inventive mixtures wherein the compound II of group A is fenazaquin and the compound of formula I is a compound of Table 12.

Especially preferred are the inventive mixtures wherein the compound II of group A is fenazaquin and the compound of formula I is a compound of Table 13.

Especially preferred are the inventive mixtures wherein the compound II of group A is fenazaquin and the compound of formula I is a compound of Table 14.

Especially preferred are the inventive mixtures wherein the compound II of group A is fenazaquin and the compound of formula I is a compound of Table 15.

Especially preferred are the inventive mixtures wherein the compound II of group A is fenazaquin and the compound of formula I is a compound of Table 19.

Especially preferred are the inventive mixtures wherein the compound II of group A is fenazaquin and the compound of formula I is a compound of Table 21.

Especially preferred are the inventive mixtures wherein the compound II of group A is fenazaquin and the compound of formula I is a compound of Table 22.

Especially preferred are the inventive mixtures wherein the compound II of group A is pyridaben and the compound of formula I is a compound of Table 1.

Especially preferred are the inventive mixtures wherein the compound II of group A is pyridaben and the compound of formula I is a compound of Table 2.

Especially preferred are the inventive mixtures wherein the compound II of group A is pyridaben and the compound of formula I is a compound of Table 3.

Especially preferred are the inventive mixtures wherein the compound II of group A is pyridaben and the compound of formula I is a compound of Table 4.

Especially preferred are the inventive mixtures wherein the compound II of group A is pyridaben and the compound of formula I is a compound of Table 8.

Especially preferred are the inventive mixtures wherein the compound II of group A is pyridaben and the compound of formula I is a compound of Table 10.

Especially preferred are the inventive mixtures wherein the compound II of group A is pyridaben and the compound of formula I is a compound of Table 11.

Especially preferred are the inventive mixtures wherein the compound II of group A is pyridaben and the compound of formula I is a compound of Table 12.

Especially preferred are the inventive mixtures wherein the compound II of group A is pyridaben and the compound of formula I is a compound of Table 13.

Especially preferred are the inventive mixtures wherein the compound II of group A is pyridaben and the compound of formula I is a compound of Table 14.

Especially preferred are the inventive mixtures wherein the compound II of group A is pyridaben and the compound of formula I is a compound of Table 15.

Especially preferred are the inventive mixtures wherein the compound II of group A is pyridaben and the compound of formula I is a compound of Table 19.

Especially preferred are the inventive mixtures wherein the compound II of group A is pyridaben and the compound of formula I is a compound of Table 21.

Especially preferred are the inventive mixtures wherein the compound II of group A is pyridaben and the compound of formula I is a compound of Table 22.

Especially preferred are the inventive mixtures wherein the compound II of group A is tebufenpyrad and the compound of formula I is a compound of Table 1.

Especially preferred are the inventive mixtures wherein the compound II of group A is tebufenpyrad and the compound of formula I is a compound of Table 2.

Especially preferred are the inventive mixtures wherein the compound II of group A is tebufenpyrad and the compound of formula I is a compound of Table 3.

Especially preferred are the inventive mixtures wherein the compound II of group A is tebufenpyrad and the compound of formula I is a compound of Table 4.

Especially preferred are the inventive mixtures wherein the compound II of group A is tebufenpyrad and the compound of formula I is a compound of Table 8.

Especially preferred are the inventive mixtures wherein the compound II of group A is tebufenpyrad and the compound of formula I is a compound of Table 10.

Especially preferred are the inventive mixtures wherein the compound II of group A is tebufenpyrad and the compound of formula I is a compound of Table 11.

Especially preferred are the inventive mixtures wherein the compound II of group A is tebufenpyrad and the compound of formula I is a compound of Table 12.

Especially preferred are the inventive mixtures wherein the compound II of group A is tebufenpyrad and the compound of formula I is a compound of Table 13.

Especially preferred are the inventive mixtures wherein the compound II of group A is tebufenpyrad and the compound of formula I is a compound of Table 14.

Especially preferred are the inventive mixtures wherein the compound II of group A is tebufenpyrad and the compound of formula I is a compound of Table 15.

Especially preferred are the inventive mixtures wherein the compound II of group A is tebufenpyrad and the compound of formula I is a compound of Table 19.

Especially preferred are the inventive mixtures wherein the compound II of group A is tebufenpyrad and the compound of formula I is a compound of Table 21.

Especially preferred are the inventive mixtures wherein the compound II of group A is tebufenpyrad and the compound of formula I is a compound of Table 22.

Especially preferred are the inventive mixtures wherein the compound II of group A is diafenthiuron and the compound of formula I is a compound of Table 1.

Especially preferred are the inventive mixtures wherein the compound II of group A is diafenthiuron and the compound of formula I is a compound of Table 2.

Especially preferred are the inventive mixtures wherein the compound II of group A is diafenthiuron and the compound of formula I is a compound of Table 3.

Especially preferred are the inventive mixtures wherein the compound II of group A is diafenthiuron and the compound of formula I is a compound of Table 4.

Especially preferred are the inventive mixtures wherein the compound II of group A is diafenthiuron and the compound of formula I is a compound of Table 8.

Especially preferred are the inventive mixtures wherein the compound II of group A is diafenthiuron and the compound of formula I is a compound of Table 10.

Especially preferred are the inventive mixtures wherein the compound II of group A is diafenthiuron and the compound of formula I is a compound of Table 11.

Especially preferred are the inventive mixtures wherein the compound II of group A is diafenthiuron and the compound of formula I is a compound of Table 12.

Especially preferred are the inventive mixtures wherein the compound II of group A is diafenthiuron and the compound of formula I is a compound of Table 13.

Especially preferred are the inventive mixtures wherein the compound II of group A is diafenthiuron and the compound of formula I is a compound of Table 14.

Especially preferred are the inventive mixtures wherein the compound II of group A is diafenthiuron and the compound of formula I is a compound of Table 15.

Especially preferred are the inventive mixtures wherein the compound II of group A is diafenthiuron and the compound of formula I is a compound of Table 19.

Especially preferred are the inventive mixtures wherein the compound II of group A is diafenthiuron and the compound of formula I is a compound of Table 21.

Especially preferred are the inventive mixtures wherein the compound II of group A is diafenthiuron and the compound of formula I is a compound of Table 22.

Especially preferred are the inventive mixtures wherein the compound II of group A is propargite and the compound of formula I is a compound of Table 1.

Especially preferred are the inventive mixtures wherein the compound II of group A is propargite and the compound of formula I is a compound of Table 2.

Especially preferred are the inventive mixtures wherein the compound II of group A is propargite and the compound of formula I is a compound of Table 3.

Especially preferred are the inventive mixtures wherein the compound II of group A is propargite and the compound of formula I is a compound of Table 4.

Especially preferred are the inventive mixtures wherein the compound II of group A is propargite and the compound of formula I is a compound of Table 8.

Especially preferred are the inventive mixtures wherein the compound II of group A is propargite and the compound of formula I is a compound of Table 10.

Especially preferred are the inventive mixtures wherein the compound II of group A is propargite and the compound of formula I is a compound of Table 11.

Especially preferred are the inventive mixtures wherein the compound II of group A is propargite and the compound of formula I is a compound of Table 12.

Especially preferred are the inventive mixtures wherein the compound II of group A is propargite and the compound of formula I is a compound of Table 13.

Especially preferred are the inventive mixtures wherein the compound II of group A is propargite and the compound of formula I is a compound of Table 14.

Especially preferred are the inventive mixtures wherein the compound II of group A is propargite and the compound of formula I is a compound of Table 15.

Especially preferred are the inventive mixtures wherein the compound II of group A is propargite and the compound of formula I is a compound of Table 19.

Especially preferred are the inventive mixtures wherein the compound II of group A is propargite and the compound of formula I is a compound of Table 21.

Especially preferred are the inventive mixtures wherein the compound II of group A is propargite and the compound of formula I is a compound of Table 22.

Especially preferred are the inventive mixtures wherein the compound II of group A is indoxacarb and the compound of formula I is a compound of Table 1.

Especially preferred are the inventive mixtures wherein the compound II of group A is indoxacarb and the compound of formula I is a compound of Table 2.

Especially preferred are the inventive mixtures wherein the compound II of group A is indoxacarb and the compound of formula I is a compound of Table 3.

Especially preferred are the inventive mixtures wherein the compound II of group A is indoxacarb and the compound of formula I is a compound of Table 4.

Especially preferred are the inventive mixtures wherein the compound II of group A is indoxacarb and the compound of formula I is a compound of Table 8.

Especially preferred are the inventive mixtures wherein the compound II of group A is indoxacarb and the compound of formula I is a compound of Table 10.

Especially preferred are the inventive mixtures wherein the compound II of group A is indoxacarb and the compound of formula I is a compound of Table 11.

Especially preferred are the inventive mixtures wherein the compound II of group A is indoxacarb and the compound of formula I is a compound of Table 12.

Especially preferred are the inventive mixtures wherein the compound II of group A is indoxacarb and the compound of formula I is a compound of Table 13.

Especially preferred are the inventive mixtures wherein the compound II of group A is indoxacarb and the compound of formula I is a compound of Table 14.

Especially preferred are the inventive mixtures wherein the compound II of group A is indoxacarb and the compound of formula I is a compound of Table 15.

Especially preferred are the inventive mixtures wherein the compound II of group A is indoxacarb and the compound of formula I is a compound of Table 19.

Especially preferred are the inventive mixtures wherein the compound II of group A is indoxacarb and the compound of formula I is a compound of Table 21.

Especially preferred are the inventive mixtures wherein the compound II of group A is indoxacarb and the compound of formula I is a compound of Table 22.

Especially preferred are the inventive mixtures wherein the compound II of group A is metaflumizone and the compound of formula I is a compound of Table 1.

Especially preferred are the inventive mixtures wherein the compound II of group A is metaflumizone and the compound of formula I is a compound of Table 2.

Especially preferred are the inventive mixtures wherein the compound II of group A is metaflumizone and the compound of formula I is a compound of Table 3.

Especially preferred are the inventive mixtures wherein the compound II of group A is metaflumizone and the compound of formula I is a compound of Table 4.

Especially preferred are the inventive mixtures wherein the compound II of group A is metaflumizone and the compound of formula I is a compound of Table 8.

Especially preferred are the inventive mixtures wherein the compound II of group A is metaflumizone and the compound of formula I is a compound of Table 10.

Especially preferred are the inventive mixtures wherein the compound II of group A is metaflumizone and the compound of formula I is a compound of Table 11.

Especially preferred are the inventive mixtures wherein the compound II of group A is metaflumizone and the compound of formula I is a compound of Table 12.

Especially preferred are the inventive mixtures wherein the compound II of group A is metaflumizone and the compound of formula I is a compound of Table 13.

Especially preferred are the inventive mixtures wherein the compound II of group A is metaflumizone and the compound of formula I is a compound of Table 14.

Especially preferred are the inventive mixtures wherein the compound II of group A is metaflumizone and the compound of formula I is a compound of Table 15.

Especially preferred are the inventive mixtures wherein the compound II of group A is metaflumizone and the compound of formula I is a compound of Table 19.

Especially preferred are the inventive mixtures wherein the compound II of group A is metaflumizone and the compound of formula I is a compound of Table 21.

Especially preferred are the inventive mixtures wherein the compound II of group A is metaflumizone and the compound of formula I is a compound of Table 22.

Especially preferred are the inventive mixtures wherein the compound II of group A is flonicamid and the compound of formula I is a compound of Table 1.

Especially preferred are the inventive mixtures wherein the compound II of group A is flonicamid and the compound of formula I is a compound of Table 2.

Especially preferred are the inventive mixtures wherein the compound II of group A is flonicamid and the compound of formula I is a compound of Table 3.

Especially preferred are the inventive mixtures wherein the compound II of group A is flonicamid and the compound of formula I is a compound of Table 4.

Especially preferred are the inventive mixtures wherein the compound II of group A is flonicamid and the compound of formula I is a compound of Table 8.

Especially preferred are the inventive mixtures wherein the compound II of group A is flonicamid and the compound of formula I is a compound of Table 10.

Especially preferred are the inventive mixtures wherein the compound II of group A is flonicamid and the compound of formula I is a compound of Table 11.

Especially preferred are the inventive mixtures wherein the compound II of group A is flonicamid and the compound of formula I is a compound of Table 12.

Especially preferred are the inventive mixtures wherein the compound II of group A is flonicamid and the compound of formula I is a compound of Table 13.

Especially preferred are the inventive mixtures wherein the compound II of group A is flonicamid and the compound of formula I is a compound of Table 14.

Especially preferred are the inventive mixtures wherein the compound II of group A is flonicamid and the compound of formula I is a compound of Table 15.

Especially preferred are the inventive mixtures wherein the compound II of group A is flonicamid and the compound of formula I is a compound of Table 19.

Especially preferred are the inventive mixtures wherein the compound II of group A is flonicamid and the compound of formula I is a compound of Table 21.

Especially preferred are the inventive mixtures wherein the compound II of group A is flonicamid and the compound of formula I is a compound of Table 22.

Especially preferred are the inventive mixtures wherein the compound II of group A is pyridalyl and the compound of formula I is a compound of Table 1.

Especially preferred are the inventive mixtures wherein the compound II of group A is pyridalyl and the compound of formula I is a compound of Table 2.

Especially preferred are the inventive mixtures wherein the compound II of group A is pyridalyl and the compound of formula I is a compound of Table 3.

Especially preferred are the inventive mixtures wherein the compound II of group A is pyridalyl and the compound of formula I is a compound of Table 4.

Especially preferred are the inventive mixtures wherein the compound II of group A is pyridalyl and the compound of formula I is a compound of Table 8.

Especially preferred are the inventive mixtures wherein the compound II of group A is pyridalyl and the compound of formula I is a compound of Table 10.

Especially preferred are the inventive mixtures wherein the compound II of group A is pyridalyl and the compound of formula I is a compound of Table 11.

Especially preferred are the inventive mixtures wherein the compound II of group A is pyridalyl and the compound of formula I is a compound of Table 12.

Especially preferred are the inventive mixtures wherein the compound II of group A is pyridalyl and the compound of formula I is a compound of Table 13.

Especially preferred are the inventive mixtures wherein the compound II of group A is pyridalyl and the compound of formula I is a compound of Table 14.

Especially preferred are the inventive mixtures wherein the compound II of group A is pyridalyl and the compound of formula I is a compound of Table 15.

Especially preferred are the inventive mixtures wherein the compound II of group A is pyridalyl and the compound of formula I is a compound of Table 19.

Especially preferred are the inventive mixtures wherein the compound II of group A is pyridalyl and the compound of formula I is a compound of Table 21.

Especially preferred are the inventive mixtures wherein the compound II of group A is pyridalyl and the compound of formula I is a compound of Table 22.

When preparing the mixtures, it is preferred to employ the pure active compounds I and II, to which further active compounds, also against harmful fungi or else herbicidal or growth-regulating active compounds or fertilizers can be added.

The mixtures of compounds I and II, or the compounds I and II used simultaneously, that is jointly or separately, exhibit outstanding action against pests from the following orders:

insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Chematobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardefia, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,

beetles (Coleoptera), for example Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicornis, Diabrotica semipunctata, Diabrotica 12-punctata Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popiffia japonica, Sitona lineatus and Sitophilus granaria,

flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chtysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia cuprina, Lucilia cuprina, Lucilia sericata, Lycoria pectoralis, Mansonia titillanus, Mayetiola destructor, Musca domestica, Muscina stabulans, Oestrus ovis, Opomyza florum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga sp., Simulium vittatum, Stomoxys calcitrans, Tabanus bovinus, Tabanus atratus, Tabanus lineola, and Tabanus similis, Tipula oleracea, and Tipula paludosa

thrips (Thysanoptera), e.g. Dichromothrips corbetti, Dichromothrips ssp, Frankliniella fusca, Frankliniella occidentalis, Frankliniella tritici, Scirtothrips citri, Thrips oryzae, Thrips palmi and Thrips tabaci,

termites (Isoptera), e.g. Calotermes Leucotermes flavipes, Heterotermes aureus, Reticulitermes flavipes, Reticulitermes virginicus, Reticulitermes lucifugus, Termes natalensis, and Coptotermes formosanus,

cockroaches (Blattaria-Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis,

true bugs (Hemiptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis, Thyanta perditor, Acyrthosiphon onobrychis, Adelges Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, Viteus vitifolii, Cimex lectularius, Cimex hemipterus, Reduvius senilis, Triatoma spp., and Arilus critatus.

ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex californicus, Pheidole megacephala, Dasymutilla occidentalis, Bombus spp. Vespula squamosa, Paravespula vulgaris, Paravespula pennsylvanica, Paravespula germanica, Dolichovespula maculata, Vespa crabro, Polistes rubiginosa, Camponotus floridanus, and Linepithema humile,

crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera, and Locustana pardalina,

Arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophilus annulatus, Boophilus decoloratus, Boophilus microplus, Dermacentor silvarum, Dermacentor andersoni, Dermacentor variabilis, Hyalomma truncatum, Ixodes ricinus, Ixodes rubicundus, Ixodes scapularis, Ixodes holocyclus, Ixodes pacificus, Ornithodorus moubata, Ornithodorus hermsi, Ornithodorus turicata, Ornithonyssus bacoti, Otobius megnini, Dermanyssus gallinae, Psoroptes ovis, Rhipicephalus sanguineus, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and Oligonychus pratensis; Araneida, e.g. Latrodectus mactans, and Loxosceles recluse,

fleas (Siphonaptera), e.g. Ctenocephalides felis, Ctenocephalides canis, Xenopsylla cheopis, Pulex irritans, Tunga penetrans, and Nosopsyllus fasciatus,

silverfish, firebrat (Thysanura), e.g. Lepisma saccharina and Thermobia domestica,

centipedes (Chilopoda), e.g. Scutigera coleoptrata,

millipedes (Diplopoda), e.g. Narceus spp.,

Earwigs (Dermaptera), e.g. forficula auricularia,

lice (Phthiraptera), e.g. Pediculus humanus capitis, Pediculus humanus corporis, Pthirus pubis, Haematopinus eurystemus, Haematopinus suis, Linognathus vituli, Bovicola bovis, Menopon gallinae, Menacanthus stramineus and Solenopotes capillatus.

Plant parasitic nematodes such as root-knot nematodes, Meloidogyne arenaria, Meloidogyne chitwoodi, Meloidogyne exigua, Meloidogyne hapla, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii, and other Heterodera species; seed gall nematodes, Anguina funesta, Anguina tritici and other Anguina species; stem and foliar nematodes, Aphelenchoides besseyi, Aphelenchoides fragariae, Aphelenchoides ritzemabosi and other Aphelenchoides species; sting nematodes, Belonolaimus longicaudatus and other Belonolaimus species; pine nematodes, Bursaphelenchus xylophilus and other Bursaphelenchus species; ring nematodes, Criconema species, Criconemella species, Criconemoides species, and Mesocriconema species; stem and bulb nematodes, Ditylenchus destructor, Ditylenchus dipsaci, Ditylenchus myceliophagus and other Ditylenchus species; awl nematodes, Dolichodorus species; spiral nematodes, Helicotylenchus dihystera, Helicotylenchus multicinctus and other Helicotylenchus species, Rotylenchus robustus and other Rotylenchus species; sheath nematodes, Hemicycliophora species and Hemicriconemoides species; Hirshmanniella species; lance nematodes, Hoplolaimus columbus, Hoplolaimus galeatus and other Hoplolaimus species; false root-knot nematodes, Nacobbus aberrans and other Nacobbus species; needle nematodes, Longidorus elongates and other Longidorus species; pin nematodes, Paratylenchus species; lesion nematodes, Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species; Radinaphelenchus cocophilus and other Radinaphelenchus species; burrowing nematodes, Radopholus similis and other Radopholus species; reniform nematodes, Rotylenchulus reniformis and other Rotylenchulus species; Scutellonema species; stubby root nematodes, Trichodorus primitivus and other Trichodorus species; Paratrichodorus minor and other Paratrichodorus species; stunt nematodes, Tylenchorhynchus claytoni, Tylenchorhynchus dubius and other Tylenchorhynchus species and Merlinius species; citrus nematodes, Tylenchulus semipenetrans and other Tylenchulus species; dagger nematodes, Xiphinema americanum, Xiphinema index, Xiphinema diversicaudatum and other Xiphinema species; and other plant parasitic nematode species.

Moreover, the inventive mixtures are especially useful for the control of Lepidoptera, Coleoptera, Diptera, Thysanoptera and Hymenoptera.

Moreover, the inventive mixtures are especially useful for the control of non-crop pests (household, turf, ornamental).

For use according to the present invention, the compounds I can be converted into the customary formulations.

The formulations are prepared in a known manner (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), for example by extending the active compound with auxiliaries suitable for the formulation of agrochemicals, such as solvents and/or carriers, if desired emulsifiers, surfactants and dispersants, preservatives, antifoaming agents, anti-freezing agents, for seed treatment formulation also optionally colorants and binders.

Examples of suitable solvents are water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.

Examples of suitable carriers are ground natural minerals (for example kaolins, clays, talc, chalk) and ground synthetic minerals (for example highly disperse silica, silicates).

Suitable emulsifiers are nonionic and anionic emulsifiers (for example polyoxyethylene fatty alcohol ethers, alkylsulfonates and arylsulfonates).

Examples of dispersants are lignin-sulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Also anti-freezing agents such as glycerin, ethylene glycol, propylene glycol and bactericides such as can be added to the formulation.

Suitable antifoaming agents are for example antifoaming agents based on silicon or magnesium stearate.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound(s). In this case, the active compound(s) are employed in a purity of from 90% to 100% by weight, preferably 95% to 100% by weight (according to NMR spectrum).

The compounds of formula I can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compound(s) according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1% per weight.

The active compound(s) may also be used successfully in the ultra-low-volume process (ULV), it being possible to apply formulations comprising over 95% by weight of active compound, or even to apply the active compound without additives.

The following are examples of formulations: 1. Products for dilution with water for foliar applications.

A) Water-Soluble Concentrates (SL, LS)

10 parts by weight of the active compound(s) are dissolved in 90 parts by weight of water or a water-soluble solvent. As an alternative, wetters or other auxiliaries are added. The active compound(s) dissolves upon dilution with water, whereby a formulation with 10% (w/w) of active compound(s) is obtained.

B) Dispersible Concentrates (DC)

20 parts by weight of the active compound(s) are dissolved in 75 parts by weight of cyclohexanone with addition of 10 parts by weight of a dispersant, for example polyvinylpyrrolidone. Dilution with water gives a dispersion, whereby a formulation with 20% (w/w) of active compound(s) is obtained.

C) Emulsifiable Concentrates (EC)

15 parts by weight of the active compound(s) are dissolved in 75 parts by weight of xylene with addition of calcium dodecylbenzenesulfonate and castor oil ethoxylate (in each case 5 parts by weight). Dilution with water gives an emulsion, whereby a formulation with 15% (w/w) of active compound(s) is obtained.

D) Emulsions (EW, EO, ES)

40 parts by weight of the active compound(s) are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active compound(s) is obtained.

E) Suspensions (SC, OD, FS)

In an agitated ball mill, 20 parts by weight of the active compound(s) are comminuted with addition of 10 parts by weight of dispersants, wetters and 70 parts by weight of water or of an organic solvent to give a fine active compound(s) suspension. Dilution with water gives a stable suspension of the active compound(s), whereby a formulation with 20% (w/w) of active compound(s) is obtained.

F) Water-Dispersible Granules and Water-Soluble Granules (WG, SG)

50 parts by weight of the active compound(s) are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active compound(s), whereby a formulation with 50% (w/w) of active compound(s) is obtained.

G) Water-dispersible powders and water-soluble powders (WP, SP, WS)

75 parts by weight of the active compound(s) are ground in a rotor-stator mill with addition of 25 parts by weight of dispersants, wetters and silica gel. Dilution with water gives a stable dispersion or solution of the active compound(s) whereby a formulation with 75% (w/w) of active compound(s) is obtained.

2. Products to be applied undiluted for foliar applications.

H) Dustable Powders (DP, DS)

5 parts by weight of the active compound(s) are ground finely and mixed intimately with 95 parts by weight of finely divided kaolin. This gives a dustable product having 5% (w/w) of active compound(s)

I) Granules (GR, FG, GG, MG)

0.5 part by weight of the active compound(s) is ground finely and associated with 95.5 parts by weight of carriers, whereby a formulation with 0.5% (w/w) of active compound(s) is obtained. Current methods are extrusion, spray-drying or the fluidized bed. This gives granules to be applied undiluted for foliar use.

J) ULV Solutions (UL)

10 parts by weight of the active compound(s) are dissolved in 90 parts by weight of an organic solvent, for example xylene. This gives a product having 10% (w/w) of active compound(s), which is applied undiluted for foliar use.

Various types of oils, wetters, adjuvants, herbicides, fungicides, other pesticides, or bactericides may be added to the active ingredients, if appropriate just immediately prior to use (tank mix). These agents usually are admixed with the agents according to the invention in a weight ratio of 1:10 to 10:1.

The compounds of formula I are effective through both contact and ingestion.

According to a preferred embodiment of the invention, the compounds of formula I are employed via soil application. Soil application is especially favorable for use against ants, termites, crickets, or cockroaches.

According to another preferred embodiment of the invention, for use against non crop pests such as ants, termites, wasps, flies, mosquitoes, crickets, locusts, or cockroaches the compounds of formula I are prepared into a bait preparation.

The bait can be a liquid, a solid or a semisolid preparation (e.g. a gel).

Compositions of this invention may also contain other active ingredients, for example fungicides, herbicides, fertilizers such as ammonium nitrate, urea, potash, and superphosphate, phytotoxicants and plant growth regulators and safeners. These additional ingredients may be used sequentially or in combination with the above-described compositions, if appropriate also added only immediately prior to use (tank mix). For example, the plant(s) may be sprayed with a composition of this invention either before or after being treated with other active ingredients.

The mixtures according to the invention can be applied to any and all developmental stages, such as egg, larva, pupa, and adult. The pests may be controlled by contacting the target pest, its food supply, habitat, breeding ground or its locus with a pesticidally effective amount of the inventive mixtures or of compositions comprising the mixtures.

“Locus” means a plant, seed, soil, area, material or environment in which a pest is growing or may grow.

In general, “pesticidally effective amount” means the amount of the inventive mixtures or of compositions comprising the mixtures needed to achieve an observable effect on growth, including the effects of necrosis, death, retardation, prevention, and removal, destruction, or otherwise diminishing the occurrence and activity of the target organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

The inventive mixtures or compositions of these mixtures can also be employed for protecting plants from attack or infestation by insects, acarids or nematodes comprising contacting a plant, or soil or water in which the plant is growing.

In the context of the present invention, the term plant refers to an entire plant, a part of the plant or the propagation material of the plant, that is, the seed or the seedling.

Plants which can be treated with the inventive mixtures include all genetically modified plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

Some of the inventive mixtures have systemic action and can therefore be used for the protection of the plant shoot against foliar pests as well as for the treatment of the seed and roots against soil pests. The term seed treatment comprises all suitable seed treatment techniques known in the art, such as seed dressing, seed coating, seed dusting, seed soaking and seed pelleting.

The compounds I and the one or more compound(s) II can be applied simultaneously, that is jointly or separately, or in succession, the sequence, in the case of separate application, generally not having any effect on the result of the control measures.

The compounds I and the one or more compound(s) II are usually applied in a weight ratio of from 500:1 to 1:100, preferably from 20:1 to 1:50, in particular from 5:1 to 1:20. Depending on the desired effect, the application rates of the mixtures according to the invention are from 5 g/ha to 2000 g/ha, preferably from 50 to 1500 g/ha, in particular from 50 to 750 g/ha.

The inventive mixtures are also suitable for the protection of the seed and the seedlings' roots and shoots, preferably the seeds, against soil pests.

Conventional seed treatment formulations include for example flowable concentrates FS, solutions LS, powders for dry treatment DS, water dispersible powders WS or granules for slurry treatment, water soluble powders SS and emulsion ES. Application to the seeds is carried out before sowing, either directly on the seeds. Preferred are FS formulations.

In the treatment of seed, the application rates of the inventive mixture are generally from 0.1 to 10 kg per 100 kg of seed. The separate or joint application of the compounds I and II or of the mixtures of the compounds I and II is carried out by spraying or dusting the seeds, the seedlings, the plants or the soils before or after sowing of the plants or before or after emergence of the plants.

The invention also relates to the propagation products of plants, and especially the seed comprising, that is, coated with and/or containing, a mixture as defined above or a composition containing the mixture of two or more active ingredients or a mixture of two or more compositions each providing one of the active ingredients. The seed comprises the inventive mixtures in an amount of from 0.1 g to 10 kg per 100 kg of seed.

The inventive mixtures are effective through both contact (via soil, glass, wall, bed net, carpet, plant parts or animal parts), and ingestion (bait, or plant part) and through trophallaxis and transfer.

Preferred application methods are into water bodies, via soil, cracks and crevices, pastures, manure piles, sewers, into water, on floor, wall, or by perimeter spray application and bait.

According to another preferred embodiment of the invention, for use against non crop pests such as ants, termites, wasps, flies, mosquitoes, crickets, locusts, or cockroaches the inventive mixtures are prepared into a bait preparation.

The bait can be a liquid, a solid or a semisolid preparation (e.g. a gel). The bait employed in the composition is a product which is sufficiently attractive to incite insects such as ants, termites, wasps, flies, mosquitoes, crickets etc. or cockroaches to eat it. This attractant may be chosen from feeding stimulants or para and/or sex pheromones readily known in the art.

Methods to control infectious diseases transmitted by insects (e.g. malaria, dengue and yellow fever, lymphatic filariasis, and leishmaniasis) with the inventive mixtures and their respective compositions also comprise treating surfaces of huts and houses, air spraying and impregnation of curtains, tents, clothing items, bed nets, tsetse-fly trap or the like. Insecticidal compositions for application to fibers, fabric, knitgoods, nonwovens, netting material or foils and tarpaulins preferably comprise a composition including the inventive mixtures, optionally a repellent and at least one binder.

The inventive mixtures and the compositions comprising them can be used for protecting wooden materials such as trees, board fences, sleepers, etc. and buildings such as houses, outhouses, factories, but also construction materials, furniture, leathers, fibers, vinyl articles, electric wires and cables etc. from ants and/or termites, and for controlling ants and termites from doing harm to crops or human being (e.g. when the pests invade into houses and public facilities).

In the case of soil treatment or of application to the pests dwelling place or nest, the quantity of active ingredient ranges from 0.0001 to 500 g per 100 m², preferably from 0.001 to 20 g per 100 m².

Customary application rates in the protection of materials are, for example, from 0.01 g to 1000 g of active compound per m² treated material, desirably from 0.1 g to 50 g per m².

Insecticidal compositions for use in the impregnation of materials typically contain from 0.001 to 95 weight %, preferably from 0.1 to 45 weight %, and more preferably from 1 to 25 weight % of at least one repellent and/or insecticide.

For use in bait compositions, the typical content of active ingredient is from 0.0001 weight % to 15 weight %, desirably from 0.001 weight % to 5% weight % of active compound. The composition used may also comprise other additives such as a solvent of the active material, a flavoring agent, a preserving agent, a dye or a bitter agent. Its attractiveness may also be enhanced by a special color, shape or texture.

For use in spray compositions, the content of the mixture of the active ingredients is from 0.001 to 80 weights %, preferably from 0.01 to 50 weight % and most preferably from 0.01 to 15 weight %.

For use in treating crop plants, the rate of application of the mixture of the active ingredients of this invention may be in the range of 0.1 g to 4000 g per hectare, desirably from 25 g to 600 g per hectare, more desirably from 50 g to 500 g per hectare.

It was also an object of the present invention to provide mixtures suitable for treating, controlling, preventing and protecting warm-blooded animals, including humans, and fish against infestation and infection by pests. Problems that may be encountered with pest control on or in animals and/or humans are similar to those described at the outset, namely the need for reduced dosage rates, and/or enhanced spectrum of activity and/or combination of know-down activity with prolonged control and/or resistance management.

This invention also provides a method for treating, controlling, preventing and protecting warm-blooded animals, including humans, and fish against infestation and infection by pests of the orders Siphonaptera, Hymenoptera, Hemiptera, Orthoptera, Acarina, Phthiraptera, and Diptera, which comprises orally, topically or parenterally administering or applying to said animals a pesticidally effective amount of mixtures according to the invention.

The invention also provides a process for the preparation of a composition for treating, controlling, preventing or protecting a warm-blooded animal or a fish against infestation or infection by pests of the Siphonaptera, Hymenoptera, Hemiptera, Orthoptera, Acarina, Phthiraptera, and Diptera orders which comprises a pesticidally effective amount of a mixture according to the invention.

The above method is particularly useful for controlling and preventing infestations and infections in warm-blooded animals such as cattle, sheep, swine, camels, deer, horses, poultry, goats, dogs and cats as well as humans.

Infestations in warm-blooded animals and fish including, but not limited to, lice, biting lice, ticks, nasal bots, keds, biting flies, muscoid flies, flies, myiasitic fly larvae, chiggers, gnats, mosquitoes and fleas may be controlled, prevented or eliminated by the mixtures according to the invention.

For oral administration to warm-blooded animals, the mixtures according to the invention may be formulated as animal feeds, animal feed premixes, animal feed concentrates, pills, solutions, pastes, suspensions, drenches, gels, tablets, boluses and capsules. In addition, the mixtures according to the invention may be administered to the animals in their drinking water. For oral administration, the dosage form chosen should provide the animal with 0.01 mg/kg to 100 mg/kg of animal body weight per day of the mixture.

Alternatively, the mixtures according to the invention may be administered to animals parenterally, for example, by intraruminal, intramuscular, intravenous or subcutaneous injection. The mixtures according to the invention may be dispersed or dissolved in a physiologically acceptable carrier for subcutaneous injection. Alternatively, the mixtures according to the invention may be formulated into an implant for subcutaneous administration. In addition the mixtures according to the invention may be transdermally administered to animals. For parenteral administration, the dosage form chosen should provide the animal with 0.01 mg/kg to 100 mg/kg of animal body weight per day of the mixture.

The mixtures according to the invention may also be applied topically to the animals in the form of dips, dusts, powders, collars, medallions, sprays, spot-on and pour-on formulations. For topical application, dips and sprays usually contain 0.5 ppm to 5,000 ppm and preferably 1 ppm to 3,000 ppm of the inventive compounds. In addition, the mixtures according to the invention may be formulated as ear tags for animals, particularly quadrupeds such as cattle and sheep.

The pesticidal action of the compounds and the mixtures can be demonstrated by the experiments below:

Southern armyworm (Spodoptera eridania), 2nd instar larvae

The active compounds are formulated for testing the activity against insects and arachnids as a 10.000 ppm solution in a mixture of 35% acetone and water, which is diluted with water, if needed.

A Sieva lima bean leaf expanded to 7-8 cm in length is dipped in the test solution with agitation for 3 seconds and allowed to dry in a hood. The leaf is then placed in a 100×10 mm petri dish containing a damp filter paper on the bottom and ten 2nd instar caterpillars. At 5 days, observations are made of mortality, reduced feeding, or any interference with normal molting.

Green Peach Aphid (Myzus persicae)

The active compounds are formulated in 50:50 acetone:water and 100 ppm Kinetic™ surfactant.

Pepper plants in the 2^{nd} leaf-pair stage (variety ‘California Wonder’) are infested with approximately 40 laboratory-reared aphids by placing infested leaf sections on top of the test plants. The leaf sections are removed after 24 hr. The leaves of the intact plants are dipped into gradient solutions of the test compound and allowed to dry. Test plants are maintained under fluorescent light (24 hour photoperiod) at about 25° C. and 20-40% relative humidity. Aphid mortality on the treated plants, relative to mortality on check plants, is determined after 5 days.

Activity Against Tobacco Budworm (Heliothis virescens)

Two-leaf cotton plants are utilized for bioassays. Excised plant leaves are dipped into 1:1 acetone/water dilutions of the active compounds. After the leaves have dried, they are individually placed onto water-moistened filter paper on the bottoms of Petri dishes. Each dish is infested with 5-7 larvae and covered with a lid. Each treatment dilution is replicated 4 times. Test dishes are held at approximately 27° C. and 60% humidity. Numbers of live and morbid larvae are assessed in each dish at 5 days after treatment application, and percent mortality is calculated.

Activity against Argentine ant, harvester ant, acrobat ant, carpenter ant, fire ant, house fly, stable fly, flesh fly, yellow-fever mosquito, house mosquito, malaria mosquito, German cockroach, cat flea, and brown dog tick via glass contact

Glass vials (20 ml scintillation vials) are treated with 0.5 ml of a solution of active ingredient in acetone. Each vial is rolled uncapped for ca. 10 minutes to allow the a.i. to completely coat the vial and to allow for full drying of the acetone. Insects or ticks are placed into each vial. The vials are kept at 22° C. and are observed for treatment effects at various time intervals.

To determine if an insecticidal mixture is synergistic, Limpel's formula is used:

E=X+Y−XY/100

E=Expected % mortality of the mixture

X=% mortality of compound X, as measured independently

Y=% mortality of compound Y, as measured independently

Synergism is evident if the % observed mortality for the mixture is greater than the % expected mortality.

The test results show that the mixtures according to the invention show a considerable enhanced activity demonstrating synergism compared to the calculated sum of the single activities.

1. Pesticidal mixtures comprising, as active components,
1) an anthranilamid compound of the formula I 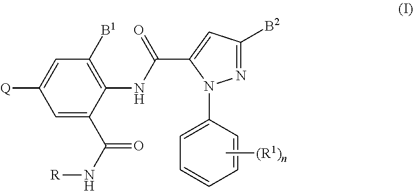
wherein
Q is hydrogen, chloro, bromo, iodo, cyano, or methyl;
B¹ is halogen, C₁-C₄-alkyl, C₁-C₄-haloalkyl, or C₁-C₄-haloalkoxy;
B² is halogen, C₁-C₄-haloalkyl, C₁-C₄-alkoxy, C₁-C₄-haloalkoxy, C₁-C₄-alkenyloxy, C₁-C₄-alkynyloxy, C₁-C₄-alkylthio, C₁-C₄-haloalkylthio, C₁-C₄-alkylsulfinyl, C₁-C₄-haloalkylsulfinyl, C₁-C₄alkylsulfonyl, C₁-C₄-haloalkylsulfonyl, C₁-C₄-alkyl-S(═O)ₓ—O— or C₁-C₄haloalkyl S(O)ₓ—O—, wherein x is 1 or 2 and the C₁-C₄-alkoxy radical may be substituted with 1-6 groups selected from halogen, cyano, C₁-C₄-alkoxy, C₁-C₄-alkoxycarbonyl, or C(Rⁱ)═N—OR^{j}, C(Rⁱ)=N(R^{j}R^{k}), wherein Rⁱ, R^{j} and R^{k} are each independently hydrogen or C₁-C₄-alkyl;
R is hydrogen, C₁-C₆-alkyl, C₂-C₆-alkenyl, C₂-C₆-alkynyl, C₃-C₆-cycloalkyl, C₁-C₄-alkylene-C₃-C₆-cycloalkyl, wherein these groups are unsubstituted or substituted with from 1 to 3 groups selected from halogen, cyano, nitro, C₁-C₆-alkyloxycarbonyl, amino, C₁-C₆-alkylamino, di(C₁-C₆-alkyl)amino, C₁-C₆-alkoxy, C₁-C₆-thioalkyl, C₁-C₆-alkylsulfinyl, C₁-C₆-alkylsulfonyl;
R¹ is fluoro, chloro, bromo, methyl, or trifluoromethyl;
n is 1, 2 or 3;
or the enantiomers or salts or N-oxides thereof, and
2) one or more compounds II selected from group A consisting of
A.1. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
A.2. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
A.3. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
A.4. Growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
A.5. Nicotinic receptor agonists/antagonists compounds: clothianidin, dinotefuran, imidacloprid, thiamethoxam, nitenpyram, acetamiprid, thiacloprid;
A.6. GABA antagonist compounds: acetoprole, endosulfan, ethiprole, fipronil, vaniliprole, pyrafluprole, pyriprole, the phenylpyrazole compound of formula Γ¹ 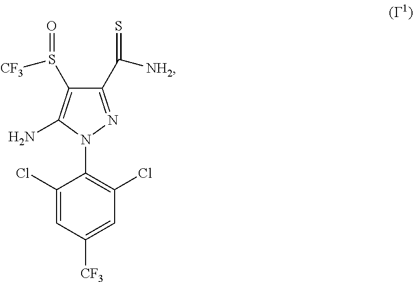
A.7. Macrocyclic lactone insecticides: abamectin, emamectin, milbemectin, lepimectin, spinosad;
A.8. METI I acaricides: fenazaquin, pyridaben, tebufenpyrad, tolfenpyrad, flufenerim;
A.9. METI II and III compounds: acequinocyl, fluacyprim, hydramethylnon;
A.10. Uncoupler compounds: chlorfenapyr;
A.11. Oxidative phosphorylation inhibitor compounds: cyhexatin, diafenthiuron, fenbutatin oxide, propargite;
A.12. Moulting disruptor compounds: cryomazine;
A.13. Mixed Function Oxidase inhibitor compounds: piperonyl butoxide;
A.14. Sodium channel blocker compounds: indoxacarb, metaflumizone,
A.15. Various: benclothiaz, bifenazate, cartap, flonicamid, pyridalyl, pymetrozine, sulfur, thiocyclam, flubendiamide, cyenopyrafen, flupyrazofos, cyflumetofen, amidoflumet, N—R′-2,2-dihalo-1-R″cyclo-propanecarboxamide-2-(2,6-dichloro-α,α,α-tri-fluoro-p-tolyl)hydrazone or N—R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl, wherein Rⁱ is —CH₂OCH₂CH₃ or H and Rⁱⁱ is CF₂CF₂CF₃ or CH₂CH(CH₃)₃, anthranilamide compounds of formula Γ² 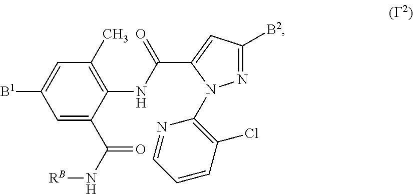
wherein B¹ is hydrogen, CN or a chlorine atom, B² is a bromine or chlorine atom, CF₃, OCH₂CF₃OCF₂H, CH═N—OCH₃, CH═NOCH₂CH₃, C(CF₃)═N—OCH₃, or C(CF₃)═N—OCH₂CH₃, and R^{B} is hydrogen, CH₃ or CH(CH₃)₂, and malononitrile compounds as described in JP 2002 284608, WO 02/89579, WO 02/90320, WO 02/90321, WO 04/06677, WO 04/20399, or JP 2004 99597,
in synergistically effective amounts.

2. Pesticidal mixtures as claimed in claim 1, wherein the compound of formula I is a compound of formula I.1 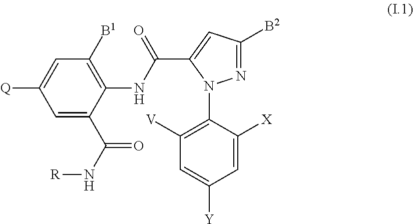
wherein
Q is chloro, bromo, iodo or cyano;
B¹ is chloro, bromo, iodo, or methyl;
B² is chloro, bromo, trifluoromethyl, 2,2,2-trifluoroethoxy, difluoromethyl, CH═N—OCH₃, or C(CF₃)═N—OCH₃;
R is hydrogen or C₁-C₄-alkyl which may be substituted with CN or SCH₃;
X is fluoro, chloro or bromo;
Y is hydrogen, fluoro or chloro;
V is hydrogen, fluoro or chloro;
or the enantiomers or salts or N-oxides thereof.

3. Pesticidal mixtures as claimed in claim 1, wherein the compound of formula II is selected from the group A-1 consisting of acetoprole, ethiprole, fipronil, vaniliprole, indoxacarb, metaflumizone, flonicamid, and pyridalyl.

4. Pesticidal mixtures as claimed in claim 1, wherein the compound of formula II is fipronil.

5. Pesticidal mixtures as claimed in claim 1, wherein the compound of formula II is indoxacarb.

6. Pesticidal mixtures as claimed in claim 1, wherein the compound of formula II is metaflumizone.

7. Pesticidal mixtures as claimed in claim 1, wherein the compound of formula II is flonicamid.

8. Pesticidal mixtures as claimed in claim 1, wherein the compound of formula II is pyridalyl.

9. Pesticidal mixtures as claimed in claim 1, comprising the compound of the formula I and the compound of the formula II in a weight ratio of from 500:1 to 1:100.

10. (canceled)

11. A method for protecting plants from attack or infestation by insects, acarids or nematodes comprising contacting the plant, or the soil or water in which the plant is growing, with a mixture as defined in claim 1 in pesticidally effective amounts.

12. A method for controlling insects, arachnids or nematode comprising contacting an insect, acarid or nematode or their food supply, habitat, breeding grounds or their locus with a mixture as defined in claim 1 in pesticidally effective amounts.

13. A method as claimed in claim 11, wherein the mixture as claimed in claim 1 is applied in an amount of from 5 g/ha to 2000 g/ha.

14. A method of protection of seed comprising contacting the seeds before sowing and/or after pregermination with a mixture as defined in claim 1 in pesticidally effective amounts.

15. A method as claimed in claim 14 wherein the mixture as claimed in claim 1 is applied in an amount of from 0.1 g to 10 kg per 100 kg of seeds.

16. Seed, comprising the mixture as claimed in claim 1 in an amount of from 0.1 g to 10 kg per 100 kg of seeds.

17. A method as claimed in claim 11, wherein the compounds I and II as defined in claim 1 are applied simultaneously, that is jointly or separately, or in succession.

18. A method for treating, controlling, preventing or protecting a warm-blooded animal or a fish against infestation or infection by parasites which comprises orally, topically or parenterally administering or applying to said animal or fish a parasiticidally effective amount of a mixture as defined in claim 1.

19. A process for the preparation of a composition for treating, controlling, preventing or protecting a warm-blooded animal or a fish against infestation or infection by insects or acarids which comprises a pesticidally effective amount of a mixture as defined in claim 1.

20. A pesticidal or parasiticidal composition, comprising a liquid or solid carrier and a mixture as claimed in claim 1.
